(19) United States
(12) Patent Application Publication
(10) Pub. No.: US 2010/0153334 A1
(43) Pub. Date: Jun. 17, 2010

(54) DATA SYNCHRONIZING APPARATUS USING INSTRUCTION

(75) Inventors: Masashi Takemura, Osaka (JP); Mitsuhiro Kageyama, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/088,058

(22) PCT Filed: Oct. 4, 2006
(86) PCT No.: PCT/JP2006/319893

§ 371 Date: Mar. 25, 2008

(30) Foreign Application Priority Data
Oct. 4, 2005 (JP) 2005-291521

(51) Int. Cl. G06F 12/00; G06F 17/30

(52) U.S. Cl. 707/610; 707/E17.005

(57) ABSTRACT

When data is synchronized among terminals which change data at any timing and become online with any desired terminal at any timing, the following problems exist: (1) If three or more terminals exist, data cannot appropriately be synchronized. (2) Change instruction conflict cannot be found. (3) Change instructions issued by a plurality of terminals cannot be reflected on data observing the order. (4) The result of solving the change instruction conflict cannot appropriately be transmitted to a different terminal.

To solve these problems, in the invention, when data is changed, a change instruction is generated and the change instruction received from a different terminal is also retained together with the change instruction in the home terminal and when data is synchronized between terminals, the retained change instruction of the different terminal is also transferred together with the change instruction of the home terminal. Information representing the situation when a change instruction is issued (ignition condition information) is retained for each change instruction and when the change instruction is reflected on data, the information is reflected and whether or not the change instruction is to be reflected on data is determined.

### TECHNICAL FIELD

This invention relates to a data synchronizing technology among data management apparatus and in particular to a technology of reflecting and synchronizing data change caused by data manipulation performed by any data management apparatus (addition of new data, data update, data deletion) in an offline (communicate-impossible) state from other data management apparatus on and with online data management apparatus when an online (communicate-possible) state is entered.

### BACKGROUND ART

In recent years, TV program production has been changed from tape production to program production in file format throughout the program production process from photographing to editing by using a camera recorder for recording on a semiconductor memory card or an optical disk in file format and a nonlinear editing machine capable of performing video editing in file format. Accordingly, a material management system for managing program material in file format has become necessary.

The program production is made up of work steps of design, photographing, editing, etc., and their work locations also vary. For example, in the photographing step, it is a common practice to photograph at a different location each time in response to the program contents or the object to be photographed. Further, the edit step is a combination of various works of rough editing, actual editing, CG editing, postrecording, etc., and locations and facilities such as an editing room in a broadcast station and an external production company are changed for each work. That is, video material is generated in various locations outside a broadcast station as well as a studio in a broadcast station in the photographing step and video material is also generated in various locations such as an editing room and an acoustic room in a broadcast station and an external production company in the editing step. Thus, considering the work steps of program production, it is considered that a method of managing all materials in a unified manner as a material management system is installed in a broadcast station is out of touch with program production as a material management method.

Therefore, in the invention, a distributed material management system is considered as the material management system. In the distributed material management system, it is assumed that material management apparatus for photographing, rough editing, actual editing, and CG editing are provided for each production step of photographing, editing, etc., and for each worker and the material generated in each step is managed for each material management apparatus. The apparatus are connected by a network and check and search for the presence and location of material required for each step and transmission and reception of the actual material are executed directly between the material management apparatus. In such a distributed material management system, to execute check and search for the presence and location of material between the material management apparatus, additional information (index data) concerning material such as the title and the location (information for identifying the apparatus managing the material and the management location in the apparatus) of the material needs to be synchronized between the material management apparatus when they are online.

As a related art of conducting data synchronization, for example, JP-A-11-272533 discloses a method of managing the preceding synchronization completion time and the last update time for each record and transmitting and receiving the record having the last update time newer than the preceding synchronization time at the synchronization processing time to synchronize data of a replica machine updated on a stand-alone basis from a master machine with master data without any contradiction in a relational database.

Each of JP-A-2001-43119 and JP-A-2005-18506 discloses an art of storing change information of data called command or journal in a first apparatus and transmitting the change information to a second apparatus for processing, thereby synchronizing the data in the second apparatus with the data in the first apparatus.

Patent document 1: JP-A-11-272533

Patent document 2: JP-A-2001-43119

Patent document 3: JP-A-2005-18506

### DISCLOSURE OF THE INVENTION

### Problems to be Solved by the Invention

In program production, usually a material management apparatus is carried to a photographing site, an editing site, etc., and new material is registered in the material management apparatus offline one after another and accordingly index data is also changed. For example, the case where one material management apparatus is carried to a photographing site and new material created by photographing is registered in the material management apparatus during an offline state because of location shooting is considered. When the material management apparatus is carried back to a broadcast station and is placed online with a material management apparatus in the broadcast station, the index data updated offline is transmitted and the index data in the material management apparatus carried to the photographing site and the index data in the material management apparatus in the broadcast station are synchronized with each other. However, the actual program production operation is more complicated; the index data in the material management apparatus in the broadcast station is changed as edited material is registered, etc., in the broadcast station concurrently with update of the index data in the material management apparatus in the photographing site on location. This means that there is a possibility that the index data may be changed (newly added, updated, deleted) at the same time in both apparatus which must be synchronized with each other.

Various apparatus to be synchronized with other exist as a plurality of photographing material management apparatus are carried to the photographing site and are placed online for synchronizing the index data, as the index data in a photographing material management apparatus and that in an editing material management apparatus are synchronized with each other in the broadcast station, etc. The case is also possible where one photographing material management apparatus is online with another photographing material management apparatus for synchronizing the index data, but is not carried back to the broadcast station and the index data in the photographing material management apparatus and that in an editing material management apparatus in the broadcast station are not synchronized with each other.

Thus, the index data must be able to be synchronized between material management apparatus in a situation in which the relationship between material management apparatus can exist as one material management apparatus arbitrarily makes a transition to an offline state or an online state with another material management apparatus, data is changed regardless of the online state or the offline state, the apparatus to synchronize with also varies in response to the situation, and they do not perform direct synchronization processing with each other depending on the operation state.

Problems when data is synchronized in the situation described above will be discussed below with examples:

For example, the case where a material management apparatus A and a material management apparatus B manage the same index data Y and while the material management apparatus A is carried to a photographing site and is in an offline state with the material management apparatus B, the index data Y is deleted and then the material management apparatus A becomes online with the material management apparatus B is considered. At this time, the material management apparatus A does not manage the index data Y and the material management apparatus B manages the index data Y. The expected synchronization processing at this time is to delete the index data Y in the material management apparatus B. On the other hand, the case where in a state in which neither the material management apparatus A nor the material management apparatus B manages the index data Y, they become offline and new index data Y is created and is managed in the material management apparatus B during the offline state and then the material management apparatus A and the material management apparatus B become online is considered. At this time, the material management apparatus A does not manage the index data Y and the material management apparatus B manages the index data Y as with the case described above. However, the expected synchronization processing at this time is to pass the index data Y to the material management apparatus A and cause the material management apparatus A to manage the index data Y.

Applying the art described in patent document 1 to such data synchronization is considered. If the data to be handled this time is deleted, the last update time managed together with the data is also deleted unlike the record in the relational database to be synchronized in patent document 1. Therefore, to perform the synchronization processing in the example described above, whether the index data Y in the material management apparatus B is to be deleted or the index data Y is to be passed to the material management apparatus A cannot be determined.

Next, the case where the material management apparatus A is carried to a photographing site and photographed material X is registered in the material management apparatus A offline with other material management apparatus is considered. When the material X is registered in the material management apparatus A, information concerning the material X is registered in index data. When location shooting terminates and the material management apparatus A is carried back to the broadcast station, the material management apparatus A becomes online with an editing material management apparatus B in the broadcast station and the index data concerning the material X is transmitted from the material management apparatus A to the editing material management apparatus B. At this time, if the index data is changed in the editing material management apparatus B, the information is transmitted to the material management apparatus A. Then, the material management apparatus A is again placed in an offline state for another location shooting. Here, the case where further a material management apparatus C is operated is considered. For example, the case where the material management apparatus C is carried to an external editing room and is offline when the material management apparatus A is carried back to the broadcast station and becomes online can be estimated. At this time, the material management apparatus C does not become online with the material management apparatus A and thus cannot acquire the index data concerning the material X. Therefore, when the material management apparatus C becomes online with the material management apparatus B, it becomes necessary for the material management apparatus C to acquire the data concerning the material X from the material management apparatus B. The case where the material management apparatus B acquires the index data concerning the material registered in the material management apparatus A from the material management apparatus C can also exist depending on the operation. Thus, it becomes necessary to transfer the change description via another apparatus between apparatus not conducting direct communications.

However, in the art disclosed in patent document 2, the command recording the change description to data is managed only in the apparatus changing the data and thus cannot be transmitted via another apparatus. In the art disclosed in patent document 3, the journal recording the change description to data is only transmitted from a predetermined main storage system to a substorage system and cannot be transferred between any desired apparatus, for example, from the material management apparatus A to the material management apparatus B, from the material management apparatus B to the material management apparatus C.

Further, the case where a mechanism of transmitting data change information called the command and the journal disclosed in patent documents 2 and 3 to another terminal, which then processes the change information, thereby transmitting the data change description is applied to the data synchronization is considered. For example, if new material X is registered in the material management apparatus A in a photographing site, change information of new creation of index data concerning the material X is generated and is stored in the material management apparatus A. When the material management apparatus A is carried back to the broadcast station and becomes online with the material management apparatus B, the change information of new creation of index data concerning the material X stored in the material management apparatus A is transmitted to the material management apparatus B, which then processes the change information, whereby the index data concerning the material X is transmitted from the material management apparatus A to the material management apparatus B. If the index data of the material X is corrected in the material management apparatus B after the material management apparatus A and the material management apparatus B become offline, change information based on the correction is generated. Thus, if the material management apparatus C receives both the change information of new creation of index data generated in the material management apparatus A and the change information of correcting index data generated in the material management apparatus B, it is necessary to process the change information of new creation before processing the change information of correcting. If an attempt is made to process the change information of correcting before the change information of new creation, it means that an attempt is made to execute processing of correcting index data not newly created, namely, non-existent index data, and appropriate processing cannot be performed; this is a problem. That is, if data change is allowed and change information is generated among apparatus, the processing order of reflecting the change information on data is important.

However, in the arts disclosed in patent documents 2 and 3, only one apparatus generates the change information called command or journal and thus the change information processing order can be observed according to a method of giving a serial number when the change information is generated in the apparatus. However, when manipulation of change, etc., can be performed on the same data in a plurality of apparatus, if the apparatus give a serial number to change information according different numbering systems and a plurality of pieces of change information generated in different apparatus are received, the change information processing order cannot be observed from the given serial numbers.

The following operation is also possible: In a state in which the material management apparatus A and the material management apparatus B manage the index data concerning the material X, the material management apparatus A again becomes an offline state with the material management apparatus B for another location shooting and a new material group is registered at the location and title information of a part of the index data of the material X is also updated because the title is erroneous, etc. On the other hand, in the editing material management apparatus B in the broadcast station, title information of the material X is also updated because the title of the material X is erroneous and the index data of the material X is synchronized with that in another material management apparatus C. In this state, if the material management apparatus A and B again become online, the title information of the material X is overwritten with either the edit result of the material management apparatus A or the edit result of the material management apparatus B. However, essentially, it is necessary to find conflict of data update that the title information is updated offline in both the material management apparatus A and the material management apparatus B and prompt the operator to select which edit result to adopt.

Further, when the material management apparatus A and B are online, if another material management apparatus C is offline because it is carried to an external edit room, etc., conflict concerning the title information of the material X again occurs when the material management apparatus A and C become online. Here, if conflict of data update is found and the worker is prompted to determine which edit result is valid, the worker must do it all over, and a different worker from the worker when A and B contended may adopt the edit result different from that adopted when the conflict of A and B was found when the conflict of A and C is found. In this case, data conflict again occurs.

The art described in patent document 2 is intended for reliably transmitting the change made in one apparatus to another apparatus as a command and reflecting the change on data; it does not assume that the same data is changed in two or more apparatus and the information is transferred therebetween. Therefore, the description on the case where data changes contend and the commands contend is not given and a method of finding conflict of the commands and a method of transmitting the solution result to another apparatus are not disclosed. The art described in patent document 3 discloses a mechanism of transmitting data change in one system to a different system using information describing the change called journal and reflecting the journal on data in the different system, thereby backing up the data. Like the art described in patent document 2, the art does not assume that the same data is changed in two or more apparatus and the information is transferred therebetween. Therefore, if data change conflict occurs and conflicting journals are generated, it is impossible to find the journal conflict and transmit the solution result to the different apparatus.

As described above, the related arts involve the following problems: Whether the data in the home apparatus is to be deleted or the data is to be passed to the associated apparatus cannot be determined as synchronization processing between the apparatus; data synchronization via another apparatus cannot be conducted; if a plurality of pieces of change information are received at a time in synchronization processing, the change information reflecting order cannot be observed; data update conflict occurring when a plurality of offline apparatus update the same data cannot be found; and the solution result of data update conflict cannot be transmitted to another apparatus.

It is therefore an object of the invention to synchronize data among apparatus in a situation in which a plurality of apparatus make a transition to an online state or an offline state, data is changed regardless of the online state or the offline state, an associated terminal for performing synchronization processing also varies depending on the situation, and an apparatus having no occasion for performing direct synchronization processing can exist.

### Means for Solving the Problems

An information processing apparatus for making a transition to a state in which the apparatus can communicate with a different information processing apparatus at any desired timing or a state in which the apparatus cannot communicate with a different information processing apparatus, wherein information is newly registered in the information processing apparatus or information managed by the information processing apparatus is updated or deleted regardless of the communication-possible state or the communication-impossible state, is characterized by the fact that it has data management means for managing information; change instruction generation means for generating change description of the information managed by the data management means as a change instruction; change instruction record means for recording a change instruction acquired from the different information processing apparatus as well as the generated change instruction in a state in which each of the change instructions is generated in which information processing apparatus can be determined; and change instruction synchronizing means for acquiring a change instruction not recorded in the change instruction record means from the different information processing apparatus by transmitting and receiving change instructions to and from the different information processing apparatus.

One embodiment of the invention is characterized in that the change instruction generation means records apparatus identification information of the information processing apparatus and the serial number generated for each apparatus by incrementing the value each time a change instruction is given in the change instruction together with the change description of the information managed by the data management means.

One embodiment of the invention is characterized in that the information processing apparatus includes ignition condition information processing means for generating ignition condition information counting the number of the change instructions managed in the change instruction management means when a change instruction is generated in the change instruction generation means for each information processing apparatus generating the change instruction, and in that the ignition condition information is further recorded in the change instruction in the change instruction generation means.

One embodiment of the invention is characterized in that an identifier for uniquely identifying the change instruction is given to the change instruction in the change instruction generation means, in that the information processing apparatus includes ignition condition information processing means for creating a list of identifiers of all change instructions managed in the change instruction management means when a change instruction is generated in the change instruction generation means and adopting the list as ignition condition information, and in that the ignition condition information is further recorded in the change instruction in the change instruction generation means.

One embodiment of the invention is characterized in that the information processing apparatus includes ignition condition information processing means for listing the change instructions managed in the change instruction management means when a change instruction is generated in the change instruction generation means and adopting the list as ignition condition information, and in that the ignition condition information is further recorded in the change instruction in the change instruction generation means.

One embodiment of the invention is characterized in that the information processing apparatus includes ignition condition information processing means for making a comparison between the ignition condition information recorded in the change instruction received from the change instruction synchronizing means and the number of the change instructions recorded in the change instruction record means for each apparatus issuing the change instruction and performing processing starting at the change instruction with the minimum total of the number of change instructions recorded in the ignition condition information among the change instructions satisfying a condition that the number of the change instructions recorded in the ignition condition information is smaller than or equal to the number of the change instructions recorded in the change instruction record means.

One embodiment of the invention is characterized in that the information processing apparatus includes conflict finding means for making a comparison between information pieces as the change targets of the change instruction received from the change instruction synchronizing section and the change instruction recorded in the change instruction record means and detecting conflicting change instructions if the change instructions are change instruction for the same information.

One embodiment of the invention is characterized in that when the conflict finding means detects conflicting change instructions, it checks to see if a change instruction for solving the conflict exists in the change instructions received from the change instruction synchronizing means, and in that if a change instruction for solving the conflict exists, the conflict finding means performs processing of determining that the change instructions detected as the conflicting change instructions are change instructions not conflicting with each other.

One embodiment of the invention is characterized in that the information processing apparatus includes conflict solution means for transmitting the change description of information recorded in any one of the change instructions determined to contend with each other to the change instruction generation means and requesting the change instruction generation means to generate a change instruction.

### ADVANTAGES OF THE INVENTION

In the material management apparatus which becomes online with a different material management apparatus at any timing for transmitting and receiving information and changes managed material regardless of the online state or the offline state with the different material management apparatus, to synchronize index data, the change description of the index data is recorded as a change instruction and the change instruction is transferred between the material management apparatus, thereby synchronizing the index data.

At this time, it is made possible to transmit the change instruction to a material management apparatus not conducting direct communications via a different material management apparatus. Accordingly, the index data can be synchronized between the material management apparatus not conducting direction communications with each other. At this time, duplicate transmission of the same change instruction and duplicate management in one material management apparatus can be eliminated. Accordingly, fruitless processing and information can be reduced.

To process a change instruction and update the index data, the processing order of the change instructions can be observed for processing the change instruction. If change instructions contend with each other, the conflict can be found and the solution result can also be transmitted to a different material management apparatus.

Thus, the index data is synchronized, it is made possible to know what material is managed in which material management apparatus in every material management apparatus, and the material required for program production can be acquired easily. Newly registered material in the material management apparatus can also be automatically transmitted when the material management apparatus becomes online with a different material management apparatus, enabling the user in the different material management apparatus to know that the new material has been registered. Accordingly, it is made possible for the user to easily acquire his or her required material without delay. Therefore, fruitless work in program production can be reduced and efficient program production can be conducted.

### BRIEF DESCRIPTION OF THE DRAWINGS

FIG. 1 is a drawing to show a use mode example of material management apparatus in an embodiment of the invention.

FIG. 2 is a block diagram to show a configuration example of the material management apparatus in the embodiment of the invention.

FIG. 3 is a block diagram to show a configuration example of an index data control section in the embodiment of the invention.

FIG. 4 is a drawing to show an example of an index data management table in the embodiment of the invention.

FIG. 5 is a drawing to show examples of change instructions in the embodiment of the invention.

FIG. 6 is a drawing to show an example of a change instruction management table in the embodiment of the invention.

FIG. 7 is a flowchart to show an operation example of a change instruction generation section in the embodiment of the invention.

FIG. 8 is a drawing to show an example of change information in the embodiment of the invention.

FIG. 9 is a drawing to show an example of ignition condition information in the embodiment of the invention.

FIG. 10 is a flowchart to show an operation example of an ignition condition information generation section in the embodiment of the invention.

FIG. 11 is a drawing to show an example of ignition condition information in the embodiment of the invention.

FIG. 12 is a flowchart to show an operation example of a change instruction processing section in the embodiment of the invention.

FIG. 13 is a drawing to show examples of index management tables in the embodiment of the invention.

FIG. 14 is a drawing to show examples of change instruction management tables in the embodiment of the invention.

FIG. 15 is a flowchart to show an operation example of a change instruction synchronizing section in the embodiment of the invention.

FIG. 16 is a flowchart to show an operation example of the change instruction synchronizing section in the embodiment of the invention.

FIG. 17 is a drawing to show examples of a change instruction management table and a change instruction in the embodiment of the invention.

FIG. 18 is a drawing to show examples of a change instruction ID list and a change instruction request list in the embodiment of the invention.

FIG. 19 is a flowchart to show an operation example of an ignition condition information processing section in the embodiment of the invention.

FIG. 20 is a drawing to show examples of change instruction management tables in the embodiment of the invention.

FIG. 21 is a flowchart to show an operation example of a conflict finding section in the embodiment of the invention.

FIG. 22 is a drawing to show examples of a change instruction management table and a change instruction in the embodiment of the invention.

FIG. 23 is a drawing to show examples of index management tables in the embodiment of the invention.

FIG. 24 is a flowchart to show an operation example of a conflict solution section in an embodiment of the invention.

FIG. 25 is a drawing to show an example of change information in the embodiment of the invention.

FIG. 26 is a drawing to show an example of change information in the embodiment of the invention.

FIG. 27 is a drawing to show one example of change information in the embodiment of the invention.

FIG. 28 is a drawing to show an example of a screen for conflict solution in the embodiment of the invention.

FIG. 29 is a block diagram to show a configuration example of a material management apparatus in an embodiment of the invention.

FIG. 30 is a drawing to show an example of an index management table in the embodiment of the invention.

### DESCRIPTION OF REFERENCE NUMERALS

3001 Data manipulation section
3002 Data management section
3003 Change instruction management section
3004 Change instruction generation section
3005 Ignition condition information generation section
3006 Change instruction processing section
3007 Change instruction synchronizing section
3008 Ignition condition information processing section
3009 Conflict finding section
3010 Conflict solution section

### BEST MODE FOR CARRYING OUT THE INVENTION

Embodiments of the invention will be discussed with reference to the accompanying drawings.

### First Embodiment

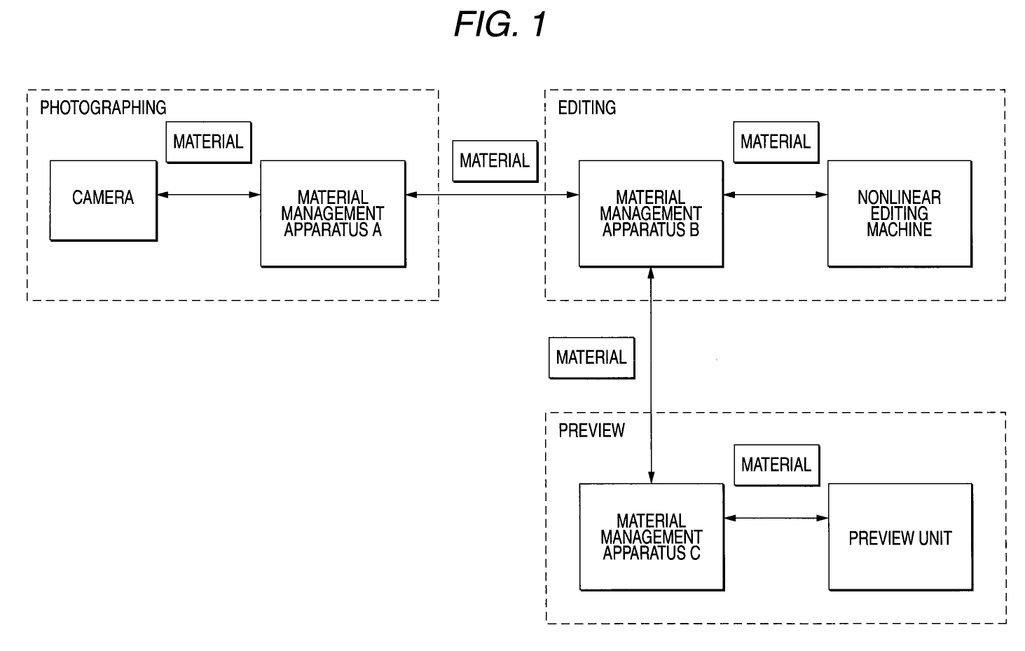

In a first embodiment, an index data synchronizing method of material in material management apparatus used for program production is disclosed. Here, a moving image in a DV format is considered as material and the title and the photographer name of the moving image are considered as index data. As shown in FIG. 1, material is registered in material management apparatus in various program production steps such as photographing, editing, and preview and is used.

The material is not limited to the moving image in the DV format and a moving image in any other format such as MPEG-2 or only audio may be adopted. The index data is not limited to the title or the photographer name; text information of the photographing date and time, the photographing location, the program name, the moving image management location (information for identifying the apparatus managing the material and the management location in the apparatus), etc., and various pieces of additional information concerning material such as a representative still image of a moving image recorded in a BMP or JPEG format are possible. For example, the photographing date and time, the photographing location, the program name, the representative still image, and the like are synchronized between the material management apparatus, whereby it is made possible to know detailed information concerning the material managed by a different material management apparatus and it is made possible to determine whether or not the material is required without acquiring the material. The location information is synchronized between the material management apparatus as the index data, whereby it is made possible to acquire the material managed by a different material management apparatus.

The material management apparatus of the invention arbitrarily makes a transition to an online state or an offline state with a different material management apparatus, and the index data is updated regardless of the offline state or the online state. A method of synchronizing the index data in such material management apparatus is disclosed in the embodiment.

(1. General Configuration)

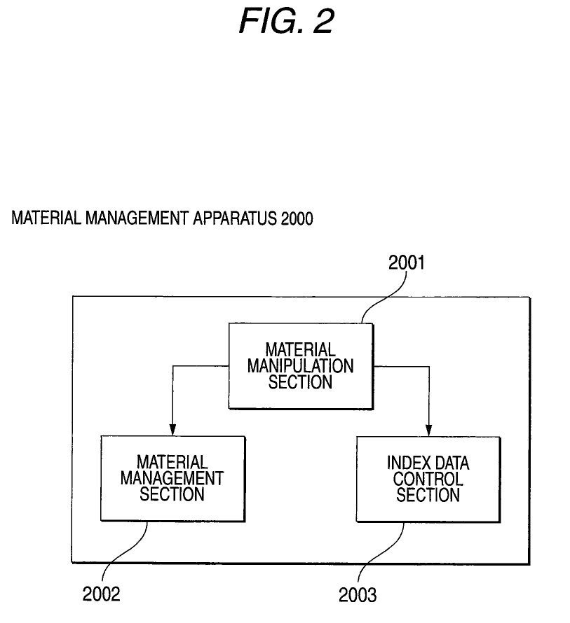

FIG. 2 shows the general configuration of the material management apparatus in the embodiment. A material management apparatus 2000 is made up of a material manipulation section 2001, a material management section 2002, and an index data control section 2003. The material manipulation section 2001 registers, changes, and deletes material in the material management section 2002, and notifies the index data control section 2003 of index data change accompanying the registration, the change, or the deletion. To change only the index data without changing the material, the change description is sent from the material manipulation section 2001 to the index data control section 2003. The material management section 2002 manages the material received from the material manipulation section 2001. The index data control section 2003 performs new creation, update, or deletion of index data sent from the material manipulation section 2001 for the retained index data. It synchronizes the index data when the material management apparatus becomes online with a different material management apparatus.

The index data control section of a component as the processing nucleus of data synchronization will be discussed below in detail:

(2. Details of index data control section)

(2-1. Configuration of index data control section)

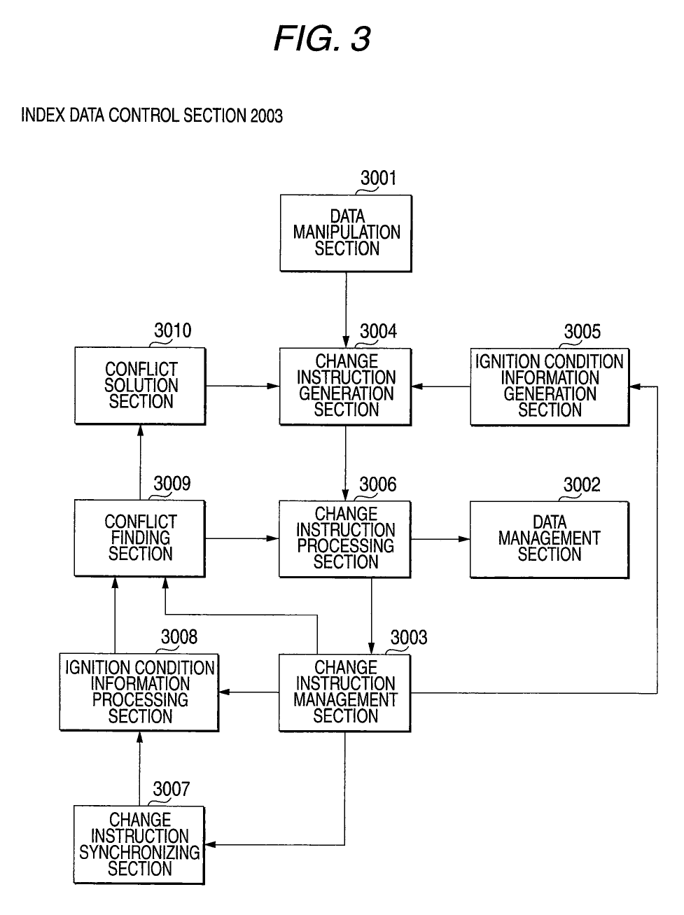

FIG. 3 shows the detailed configuration of the index data control section 2003.

To change index data from information of index data change notification received from the material manipulation section 2001, a data manipulation section 3001 transmits information concerning the index data change to a change instruction generation section 3004. The information transmitted at this time will be called “change information.” The change information at this time contains the processing description of new creation, update, deletion, etc., the processing target in the index data such as the title or the photographer name, and information required for performing processing as required, and is transmitted one piece at a time to the change instruction generation section 3004.

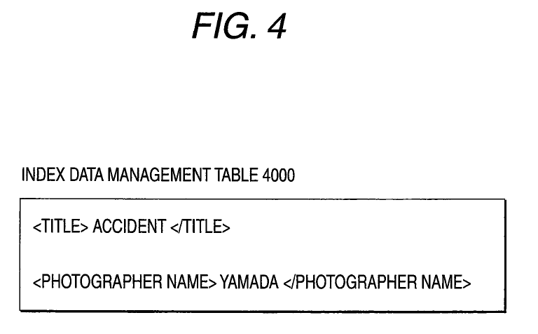

A data management section 3002 retains the index data. When the material management apparatus becomes online with a different material management apparatus, synchronizing the index data retained in the data management section 3002 is an object of the invention. The retained index data is manipulated from a change instruction processing section 3006 and new creation of index data or update or deletion of existing index data is executed in accordance with the description of a change instruction. FIG. 4 shows an example of an index data management table managed in the data management section 3002. An index data management table 4000 records “accident” of title information in the portion sandwiched between <title> and </title> and records “YAMADA” of information of the photographer name in the portion sandwiched between <photographer name> and </photographer name>. Similarity is also applied if other pieces of index data such as the photographing date and time and the program name are recorded.

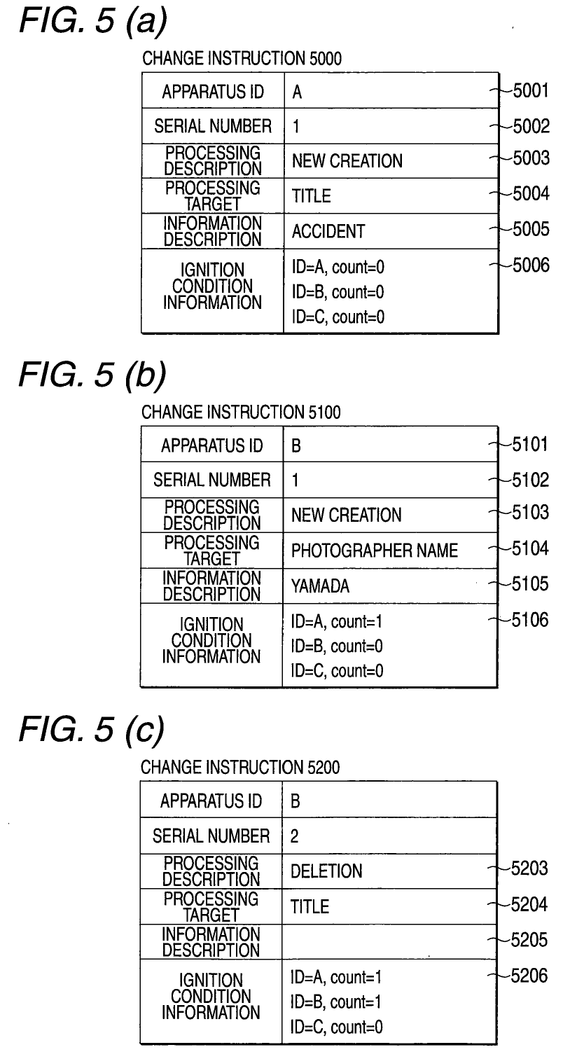

A change instruction management section 3003 retains a change instruction. The change instruction is an instruction of the change description of index data. FIGS. 5(a), (b), and (c) show examples of the change instructions. The ID of the material management apparatus generating a change instruction 5000 is recorded in a cell 5001 of the change instruction 5000. Here, the apparatus ID of material management apparatus A is A. The serial number given in the material management apparatus generating the change instruction 5000 is recorded in a cell 5002. The processing description of the index data is recorded in a cell 5003. The processing target in the index data is recorded in a cell 5004. Information description is recorded in a cell 5005 as required by the processing description recorded in the cell 5003. A cell 5205 of a change instruction 5200 is blank because the processing description recorded in a cell 5203 is “deletion” and no information is required in the processing. Ignition condition information is recorded in a cell 5006. The ignition condition information is described later in detail. According to the described information, it is seen that the change instruction 5000 is a change instruction first generated in the material management apparatus A and indicating new creation of index data with the title information as “accident.” Likewise, it is seen that a change instruction 5100 is a change instruction first generated in material management apparatus whose apparatus ID is “B” and indicating new creation of index data with the photographer name information as “YAMADA” and that the change instruction 5200 is a change instruction second generated in the material management apparatus whose apparatus ID is “B” and indicating deletion of the title information of the index data.

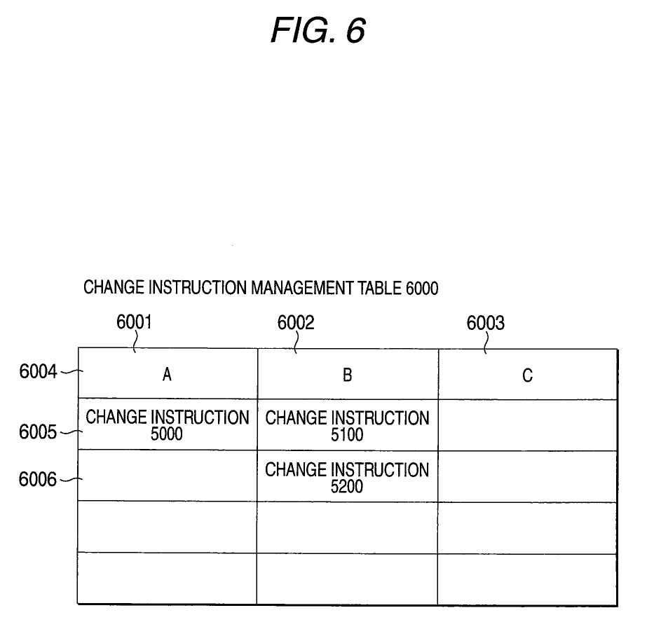

Next, FIG. 6 shows an example of a change instruction management table managed in the change instruction management section 3003. A change instruction management table 6000 shows a change instruction management table managed by the material management apparatus B in a situation in which three material management apparatus of material management apparatus A, B, and C. The apparatus IDs of the material management apparatus are described in a row 6004 so that which material management apparatus the instructions generated by are managed is seen under each column. Actual change instructions are managed in rows on and after a row 6005. For example, the change instructions are managed in rows 6005 and 6006 under a column 6002 in the order in which the material management apparatus B generated the change instructions. Likewise, the change instructions generated by the material management apparatus A and the material management apparatus C are managed under columns 6001 and 6003 respectively. For example, the change instruction first generated by the material management apparatus A is managed in the cell of the row 6005 under the column 6001. The change instruction actually managed in the cell is the change instruction 5000 shown in FIG. 5(a), but is simply described as “change instruction 5000.” Likewise, the change instruction 5200 second generated by the material management apparatus B shown in FIG. 5(c) is managed in the cell of the row 6006 under the column 6002, but is simply described as “change instruction 5200.” The change instruction 5100 shown in FIG. 5(b) is managed in the cell of the row 6005 under the column 6002, but is simply described as “change instruction 5100.” Each blank cell of the change instruction management table 6000 represents that no change instruction is managed. If the number of the change instructions to be managed increases, the number of the rows of the change instruction management table is increased accordingly and the change instructions are managed. The change instructions are not deleted or changed and a new change instruction is only added to the change instruction management table.

The change instruction generation section 3004 generates a change instruction from the two pieces of information of the change information received from the data manipulation section 3001 or a conflict solution section 3010 and the ignition condition information acquired from an ignition condition information generation section 3005.

The ignition condition information generation section 3005 generates ignition condition information from the information in the change instruction management table managed in the change instruction management section 3003 based on a request made by the change instruction generation section 3004. The generated ignition condition information is transmitted to the change instruction generation section 3004.

The change instruction processing section 3006 performs manipulation of new creation, update, or deletion on the index data management table retained by the data management section 3002 based on the change instruction received from the change instruction generation section 3004 or a conflict finding section 3009 and transmits the change instruction involved in the processing to the change instruction management section 3003.

When the material management apparatus is online with a different material management apparatus, a change instruction synchronizing section 3007 transmits and receives a change instruction managed in the change instruction management section 3003 to and from the different material management apparatus. The received change instruction is transmitted to an ignition condition information processing section 3008.

The ignition condition information processing section 3008 determines the change instruction processing order from the ignition condition information recorded in the change instructions received from the change instruction synchronizing section 3007 and transmits the instructions one at a time to the conflict finding section 3009 in accordance with the determined order.

The conflict finding section 3009 checks to see if a change instruction conflicting with the change instruction received from the ignition condition information processing section 3008 is managed in the change instruction management section 3003. The conflicting change instructions are change instructions which are generated in a plurality of material generation apparatus and contend with each other if the material generation apparatus change the same item to different values when the apparatus are offline. If a conflicting change instruction is found, the change instruction received by the ignition condition information processing section 3008 from the change instruction synchronizing section 3007 is acquired and whether or not a change instruction for solving the conflict is contained in the acquired change instructions is checked. If a change instruction for solving the conflict does not exist, the conflicting change instruction received from the ignition condition information processing section 3008 and the change instruction managed in the change instruction management section 3003 are acquired and are transmitted to the conflict solution section 3010. The change instruction received from the ignition condition information processing section 3008 is transmitted to the change instruction processing section 3006 regardless of whether or not the change instruction received from the ignition condition information processing section 3008 contends.

The conflict solution section 3010 selects the change instruction to be reflected on the data management section 3002 from two or more change instructions received from the conflict finding section 3009. Change information is created from the selected change instruction and is transmitted to the change instruction generation section 3004.

(2-2. Operation Example of Change Instruction Generation Section)

The operation of the change instruction generation section 3004 will be discussed in detail.

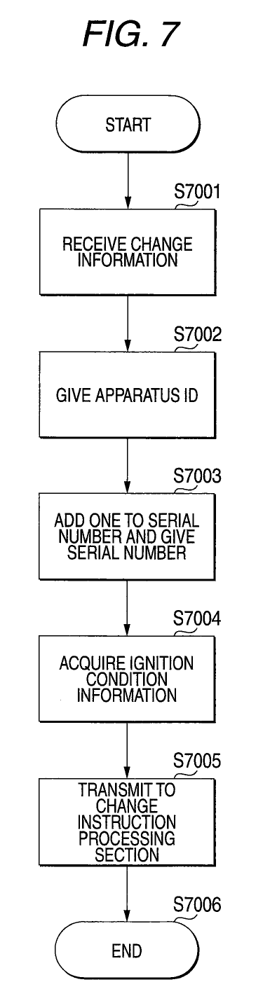

An operation flow of the change instruction generation section 3004 will be discussed with a flowchart of FIG. 7.

Change information is received from the data manipulation section 3001 or the conflict solution section 3010 and is given to a change instruction (S7001).

The previously retained apparatus ID of the material management apparatus is given to the change instruction (S7002).

One is added to the retained serial number and the serial number is given to the change instruction. The serial number to which one is added is recorded for use at the next processing time (S7003).

The ignition condition information generation section 3005 is requested to send ignition condition information and the ignition condition information is acquired and is given to the change instruction (S7004).

As the described processing is performed, the change instruction can be generated and thus is transmitted to the change instruction processing section 3006 (S7005).

The processing is terminated (S7006).

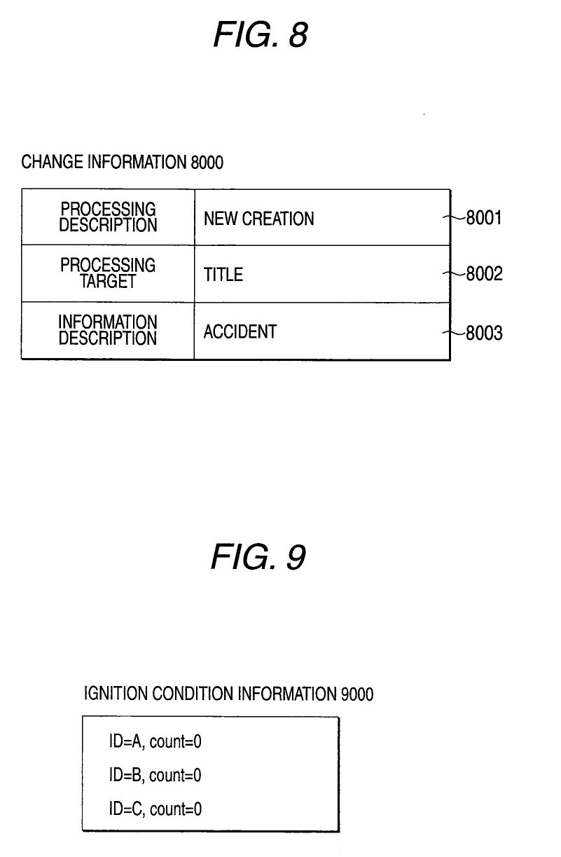

Next, processing of the change instruction generation section 3004 upon reception of change information 8000 shown in FIG. 8 will be discussed specifically. It is assumed that the material management apparatus for performing the processing is the material management apparatus A and the apparatus ID is “A.” It is assumed that the retained serial number is “0” of the initial state in which no processing is performed.

The change instruction generation section 3004 receives the change information 8000 from the data manipulation section 3001 (S7001).

The apparatus ID “A” is given to the change information 8000 received at S7001 (S7002).

One is added to the retained serial number “0” and the serial number “1” is given to the change information 8000 received at S7001. The serial number “1” is retained for the next processing (S7003).

The ignition condition information generation section 3005 is requested to send ignition condition information and the ignition condition information is acquired. Here, it is assumed that ignition condition information 9000 shown in FIG. 9 can be acquired, for example. The acquired ignition condition information 9000 is given to the change instruction (S7004).

Now, the change instruction 5000 shown in FIG. 5 (a) is generated. Information pieces recorded in cells 8001, 8002, and 8003 of the change information 8000 received at S7001 are recorded in the cells 5003, 5004, and 5005 of the change instruction 5000 in order. The apparatus ID given at S7002 is recorded in the cell 5001 of the change instruction 5000. The serial number given at S7003 is recorded in the cell 5002 of the change instruction 5000. The ignition condition information 9000 given at S7004 is recorded in the cell 5006 of the change instruction 5000. The change instruction generation section 3004 transmits the change instruction 5000 to the change instruction processing section 3006 and terminates the processing.

(2-3. Operation Example of Ignition Condition Information Generation Section)

The ignition condition information generation section 3005 generates ignition condition information based on a request made by the change instruction generation section 3004. In the embodiment, the number of change instructions managed in the change instruction management section 3003, counted for each material management apparatus generating the change instructions is used as the ignition condition information. The ignition condition information is not limited to the information used this time; information capable of identifying the instructions managed in the change instruction management section 3003 can be adopted as the ignition condition information in such a manner that identifiers capable of uniquely identifying the change instructions are used to list the identifiers of all the change instructions managed in the change instruction management section 3003 and the identifier list is used as the ignition condition information or that all the change instructions managed in the change instruction management section 3003 are listed and the change instruction list is used as the ignition condition information. In the embodiment, the number of change instructions managed in the change instruction management section 3003, counted for each material management apparatus is used because the data amount of the ignition condition information lessens.

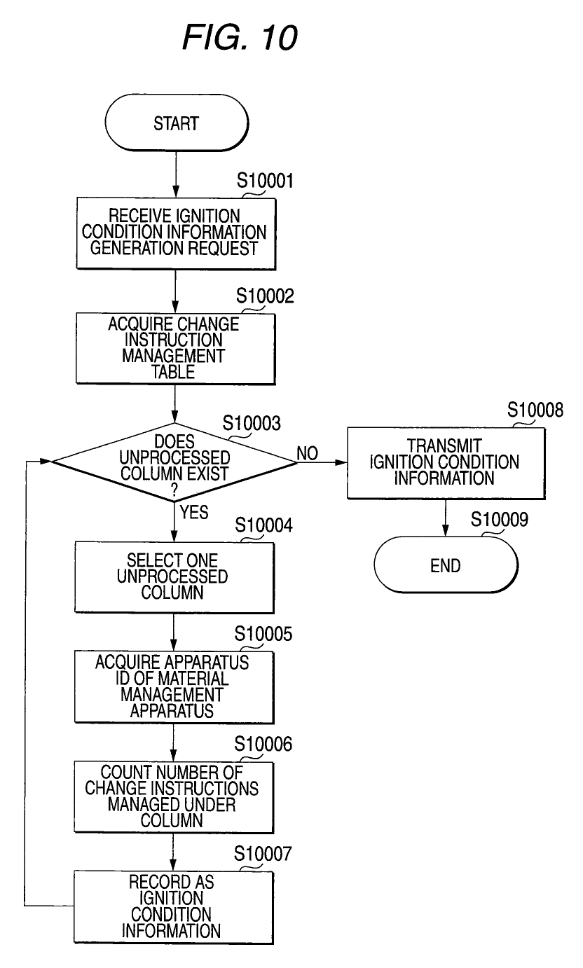

An operation flow of the ignition condition information generation section 3005 will be discussed with a flowchart of FIG. 10.

The ignition condition information generation section 3005 receives a request for generating ignition condition information from the change instruction generation section 3004 (S10001).

A change instruction management table is acquired from the change instruction management section 3003 (S10002).

Whether or not an unprocessed column exists in the change instruction management table acquired at S10002 is determined (S10003). If an unprocessed column exists, the ignition condition information generation section 3005 goes to S10004; if no unprocessed column exists, the ignition condition information generation section 3005 goes to S10008. An already processed flag is used as an example of a method of determining whether each column of the change instruction management table is already processed or is unprocessed. It is determined that the column given the already processed flag is already processed.

One unprocessed column is selected (S10004).

The apparatus ID recorded in the column selected at S10004 is acquired (S10006).

The number of change instructions recorded in the column selected at S10004 is counted (S10006).

The apparatus ID and the number of change instructions acquired at S10005 and S10006 are recorded as the ignition condition information (S10007). Then, an already processed flag is given to the processed column and the process returns to S10003 and the steps are repeated.

If it is determined at S10003 that no unprocessed column exists, the generated ignition condition information is transmitted to the change instruction management section 3003 (S10008).

The processing is terminated (S10009).

Next, processing of the ignition condition information generation section upon reception of a request for generating ignition condition information from the change instruction generation section 3004 and upon reception of the change instruction management table 6000 shown in FIG. 6 from the change instruction management section 3003 will be discussed specifically by way of example.

The ignition condition information generation section 3005 receives a request for generating ignition condition information from the change instruction generation section 3004 (S10001) and receives the change instruction management table 6000 shown in FIG. 6 from the change instruction management section 3003 (S10002).

Since no already processed flag is given, the columns 6001, 6002, and 6003 are unprocessed and thus the process goes to S10004 (S10003).

The column 6001 is selected (S10004).

The apparatus ID of the material management apparatus is acquired from the column 6001 selected at S10004 (S10005). At this time, the apparatus ID “A” recorded in the row 6004 under the column 6001 is acquired.

The number of change instructions managed under the column 6001 selected at S10004 is counted (S10006). Since only one change instruction is managed in the row 6005 under the column 6001, “1” is acquired as the result of counting the number of change instructions.

The apparatus ID “A” acquired at S10005 and the number of change instructions “1” acquired at S10006 are recorded as the ignition condition information (S10007). An already processed flag is given to the column 6001 and the process returns to S10003 and the steps are repeated.

Since the columns 6002 and 6003 are unprocessed, the process goes to S10004 (S10003).

The column 6002 is selected (S10004).

The apparatus ID “B” is acquired from the row 6004 under the column 6002 selected at S10004 is acquired (S10005).

The number of change instructions managed under the column 6002 selected at S10004 is counted (S10006). Since change instructions are managed in the rows 6005 and 6006 under the column 6002, “2” is acquired as the result of counting the number of change instructions.

The apparatus ID “B” acquired at S10005 and the number of change instructions “2” acquired at S10006 are recorded as the ignition condition information (S10007). At this time, they are added to the already recorded ignition condition information. An already processed flag is given to the column 6002 and the process returns to S10003 and the steps are repeated.

Since the column 6003 is unprocessed, the process goes to S10004 (S10003).

After this, similar processing is performed. The apparatus ID “C” and the number of change instructions “0” are acquired and are added to the ignition condition information, an already processed flag is given to the column 6003, and the process returns to S10003.

No unprocessed column exists at S10003 and therefore the process goes to S10008.

FIG. 11 shows the ignition condition information generated as the described processing is performed. “ID=A” indicates that the apparatus ID of the material management apparatus is “A” and “count=1” indicates that the number of change instructions is “1.” Therefore, “ID=A, count=1” indicates that the number of change instructions generated by the material management apparatus A is “1.” Likewise, “ID=B, count=2” indicates that the number of change instructions generated by the material management apparatus B is “2” and “ID=C, count=0” indicates that the number of change instructions generated by the material management apparatus C is “0.” Ignition condition information 11000 recording the entries is transmitted to the change instruction generation section 3004 (S10008).

The processing is now complete (S10009).

(2-4. Operation Example of Change Instruction Processing Section)

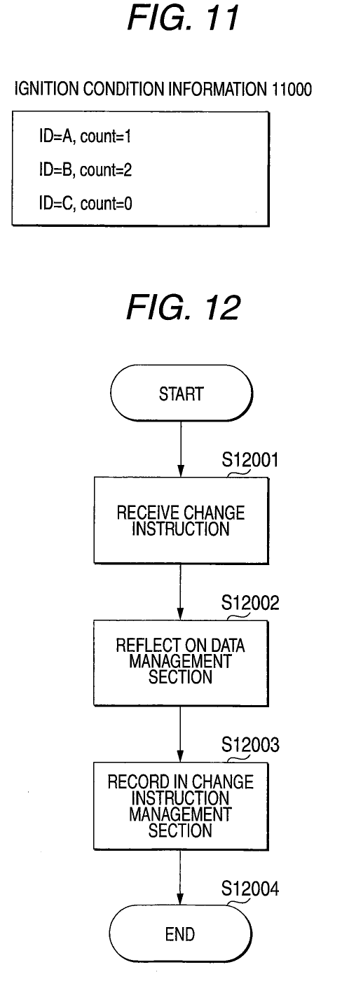

An operation flow of the change instruction processing section 3006 will be discussed with a flowchart of FIG. 12.

The change instruction processing section 3006 receives a change instruction received from the change instruction generation section 3004 or the conflict finding section 3009 (S12001).

Processing recorded in the change instruction received at S12001 is performed for the index data management table managed in the data management section 3002 (S12002).

The change instruction is recorded in the change instruction management table managed in the change instruction management section 3003 (S12003).

The processing is terminated (S12004).

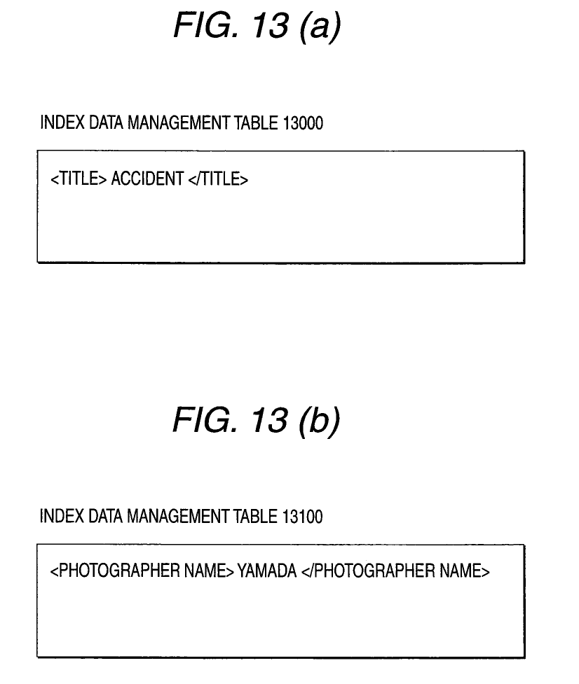

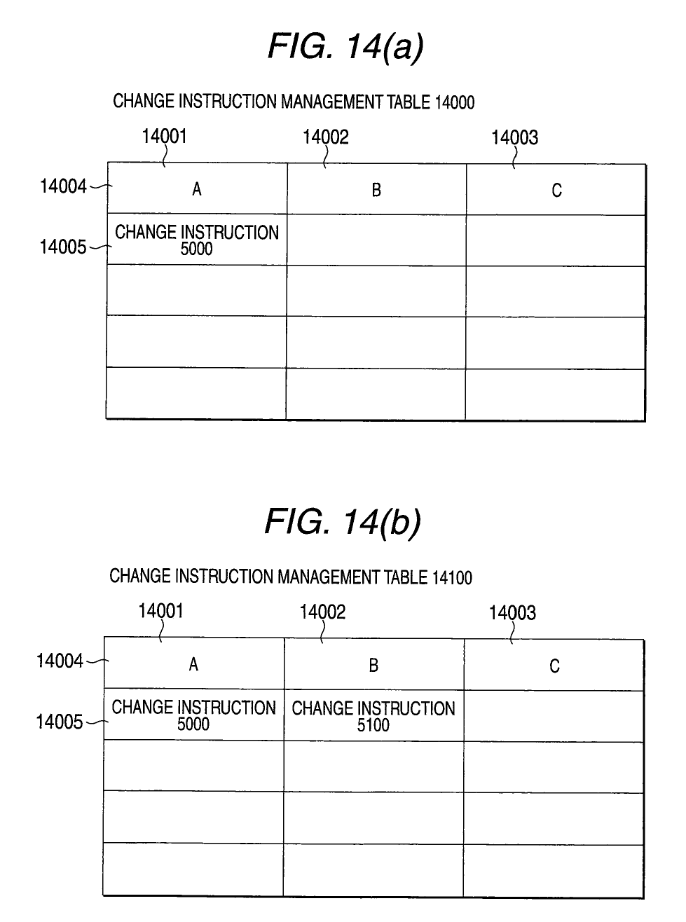

Next, processing of the change instruction processing section 3006 when the change instruction processing section 3006 receives the change instruction 5100 shown in FIG. 5 (b) in a state in which the data management section 3002 manages an index data management table 13000 shown in FIG. 13 (a) and the change instruction management section 3003 manages a change instruction management table 14000 shown in FIG. 14 (a) will be discussed specifically.

The change instruction processing section 3006 receives the change instruction 5100 at S12001.

At S12002, for the index data management table 13000 managed by the data management section 3002, an entry of “photographer name” is “newly created” with the information description as “YAMADA” from the information described in the cells 5103, 5104, and 5105 of the change instruction 5100. As the processing is performed, the index data management table 13000 managed by the data management section 3002 is placed in the state of the index data management table 4000 shown in FIG. 4.

At S12003, the change instruction 5100 is recorded in the change instruction management table 14000 managed by the change instruction management section 3003. As a result of recording the change instruction, the change instruction management table 14000 is placed in the state of a change instruction management table 14100 shown in FIG. 14 (b). The change instruction 5100 is managed in a row 14105 under a column 14102. For convenience of the description, it is simply described as “change instruction 5100.”

The processing is now complete (S12004).

Next, processing of the change instruction processing section 3006 when the change instruction processing section 3006 receives the change instruction 5200 shown in FIG. 5 (c) in a state in which the data management section 3002 manages the index data management table 4000 shown in FIG. 4 and the change instruction management section 3003 manages the change instruction management table 14100 shown in FIG. 14 (b) will be discussed specifically.

The change instruction processing section 3006 receives the change instruction 5200 at S12001.

At S12002, for the index data management table 4000 managed by the data management section 3002, entry information of “title” is “deleted” from the information described in the cells 5203 and 5204 of the change instruction 5200. As the processing is performed, the index data management table 4000 managed by the data management section 3002 is placed in the state of the index data management table 13100 shown in FIG. 13 (b).

At S12003, the change instruction 5200 is recorded in the change instruction management table 14100 managed by the change instruction management section 3003. As a result of recording the change instruction, the change instruction management table 14100 is placed in the state of the change instruction management table 6000 shown in FIG. 6. The change instruction 5200 is managed in the row 6006 under the column 6002. For convenience of the description, it is simply described as “change instruction 5200.”

The processing is now complete (S12004).

(2-5. Operation Example of Change Instruction Synchronizing Section)

The change instruction synchronizing section 3007 has a function of transmitting a change instruction to a different requesting material management apparatus in response to a request from the different material management apparatus and a function of acquiring a change instruction not managed in the change instruction management section of the home material management apparatus from a different material management apparatus. When the home material management apparatus is online with a different material management apparatus, the functions are used to acquire the change instruction not managed in the home material management apparatus from the different material management apparatus, whereby the change instruction recorded in the change instruction management table managed by the change instruction management section 3003 is synchronized.

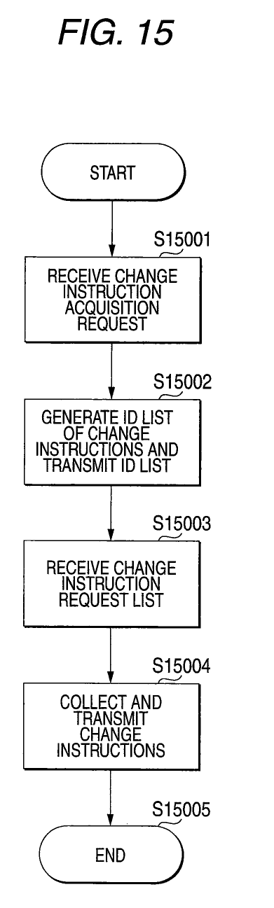

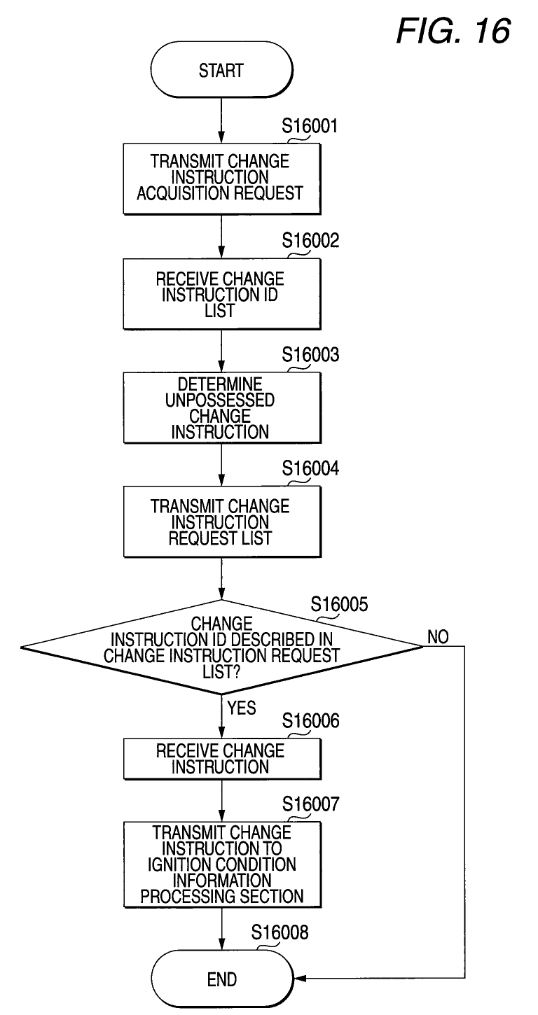

For convenience, in the description of flowcharts of FIGS. 15 and 16 and the specific description of processing involved therein, it is assumed that the material management apparatus for making a change instruction acquisition request is the material management apparatus A and that the material management apparatus for transmitting a change instruction in response to the request is the material management apparatus B. Such setting is made for convenience of the description, but each of the material management apparatus A and B has both the function of acquiring a change instruction and the function of transmitting a change instruction in response to the acquisition request and the embodiment is not limited to the operation mode in which the material management apparatus A acquires a change instruction and the material management apparatus B transmits a change instruction.

First, a processing flow when a change instruction is transmitted to the requesting material management apparatus, namely, processing of the material management apparatus B will be discussed with a flowchart of FIG. 15.

The material management apparatus B receives a change instruction acquisition request from the material management apparatus A connected through a network (S15001). The change instruction acquisition request is a message for informing the associated apparatus of the start of the processing before starting change instruction transmission-reception processing.

From the change instructions recorded in the change instruction management table managed in the change instruction management section 3003, change instruction IDs capable of uniquely identifying the change instructions are generated and the change instruction IDs of all the change instructions are listed and the list is transmitted to the material management apparatus A transmitting the change instruction acquisition request (S15002).

A change instruction request list is received from the material management apparatus A (S15003). The change instruction request list is a list of the change instruction IDs of the change instructions to be acquired by the material management apparatus A from the material management apparatus B.

The change instructions described in the change instruction request list are acquired from the change instruction management section 3003 and are transmitted to the material management apparatus A (S15004). If no change instruction ID is described in the change instruction request list, no processing is performed and the process goes to S15005.

The processing is terminated (S15005).

Next, a processing flow of the material management apparatus for making a change instruction acquisition request, namely, processing of the material management apparatus A will be discussed with a flowchart of FIG. 16.

The material management apparatus A transmits a change instruction acquisition request to the material management apparatus B connected through a network (S16001).

A change instruction ID list is received from the material management apparatus B (S16002).

A comparison is made between the change instruction ID list received at S16002 and the change instructions recorded in the change instruction management table managed in the change instruction management section 3003, and the change instruction not recorded in the change instruction management table is determined (S16003). The change instruction ID of the change instruction that can be determined not recorded in the change instruction management table is described in a change instruction request list.

The change instruction request list created at S16003 is transmitted to the material management apparatus B (S16004).

If change instruction ID is described in the change instruction request list transmitted at S16004, the process goes to S16006; if no change instruction ID is described, the process goes to S16008 (S16005).

The change instruction is received from the material management apparatus B (S16006).

The change instruction received at S16006 is transmitted to the ignition condition information processing section 3008 (S16007).

The processing is terminated (S16008).

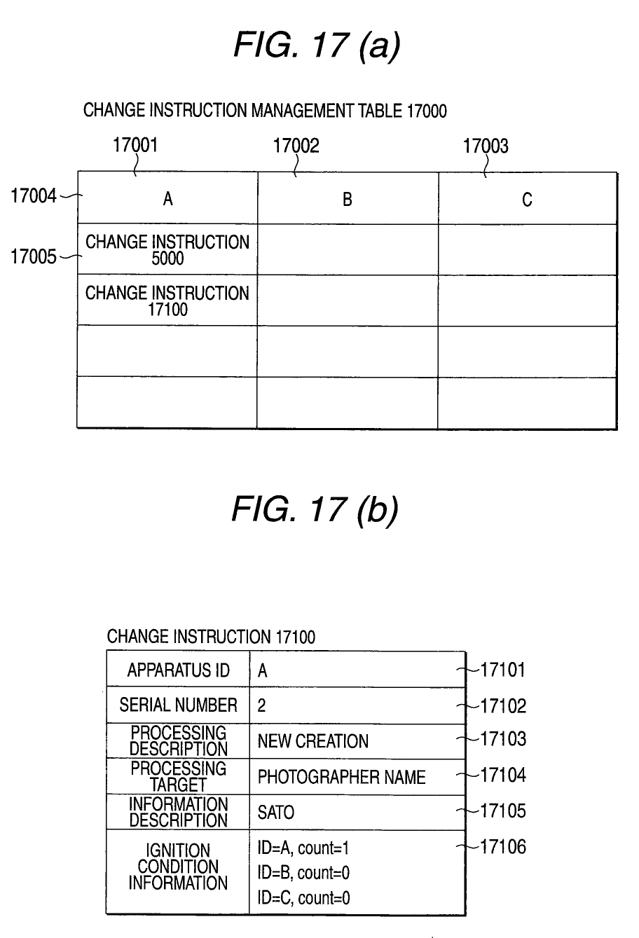

Next, processing will be discussed specifically wherein the flowchart processing shown in FIGS. 15 and 16 is performed and change instruction synchronization processing is performed when the change instruction management section 3003 of the material management apparatus A manages the change instruction 5000 and a change instruction 17100 shown in FIGS. 5 (a) and 17 (b) in a change instruction management table 17000 shown in FIG. 17 (a) and the change instruction management section 3003 of the material management apparatus B manages the change instructions 5000, 5100, and 5200 shown in FIGS. 5 (a), (b), and (c) in the change instruction management table 6000 shown in FIG. 6.

Processing of the material management apparatus B for transmitting the change instruction will be discussed.

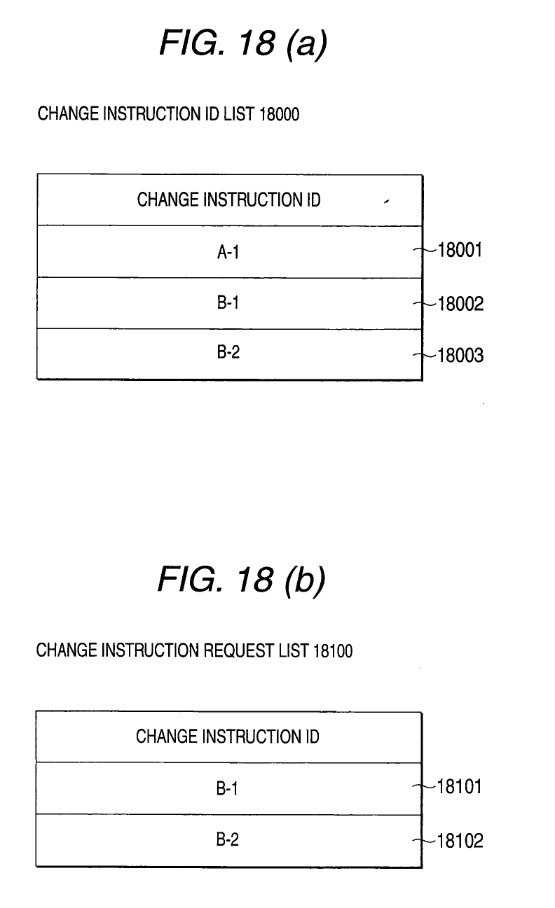

A change instruction acquisition request is received from the material management apparatus A (S15001). From the change instructions 5000, 5100, and 5200 recorded in the change instruction management table 6000 managed in the change instruction management section 3003, the change instruction IDs are generated, and a change instruction ID list is generated and is transmitted to the material management apparatus A (S15002). As the change instruction ID, concatenation of the apparatus ID and the serial number recorded in each change instruction is used. For example, for the change instruction 5000, the apparatus ID “A” and the serial number “1” is concatenated to generate change instruction ID “A-1.” Likewise, the change instruction IDs of the change instructions 5100 and 5200 are “B-1” and “B-2.” They are listed to generate a change instruction ID list. FIG. 18 (a) shows the generated change instruction ID list. “A-1,” “B-1,” and “B-2” are described in order in rows 18001, 18002, and 18003 of a change instruction ID list 18000. The change instruction ID list 18000 is transmitted to the material management apparatus A. The change instruction IDs are not limited to those used this time; the change instruction ID may be any if it is information capable of uniquely identifying the change instruction. For example, concatenation of the change instruction generation date and time information and the apparatus ID or the like can also be used.

A change instruction request list 18100 shown in FIG. 18 (b) is received as a change instruction request list from the material management apparatus A (S15003).

The change instructions of the change instruction IDs described in the change instruction request list 18100 are acquired from the change instruction management section 3003 and are transmitted to the material management apparatus A (S15004). “B-1” and “B-2” are described in rows 18101 and 18102 of the change instruction request list 18100. Therefore, the change instructions 5100 and 5200 recorded in the change instruction management table 6000 are acquired and are transmitted to the material management apparatus A.

The processing is terminated (S15005).

Next, processing of the material management apparatus A for acquiring the change instruction will be discussed.

A change instruction acquisition request is transmitted to the material management apparatus B (S16001).

The change instruction ID list 18000 is received from the material management apparatus B (S16002).

A comparison is made between the change instructions recorded in the change instruction management table 17000 managed in the change instruction management section of the material management apparatus A and the change instruction ID list 18000 received at S16002, and the change instruction not recorded in the change instruction management table 17000 is determined (S16003). In the change instruction management table 17000, the change instruction 5000 corresponding to the change instruction ID “A-1” is recorded, but the change instructions corresponding to the change instruction IDs “B-1” and “B-2” are not recorded. Therefore, the change instruction request list 18100 describing the change instruction IDs “B-1” and “B-2” is generated.

The change instruction request list 18100 created at S16003 is transmitted to the material management apparatus B (S16004).

The change instruction IDs “B-1” and “B-2” are described in the change instruction request list 18100 and thus the process goes to S16006 (S16005).

The change instructions 5100 and 5200 are received from the material management apparatus B (S16006).

The change instructions 5100 and 5200 received at S16005 are transmitted to the ignition condition information processing section 3008 of the material management apparatus A (S16007).

The processing is terminated (S16008).

Although the detailed processing is similar and therefore will not be discussed again, processing reverse to the processing described above is also performed in which the material management apparatus B acquires the change instruction and the material management apparatus A transmits the change instruction. As the processing is performed, the change instructions 5000 and 17100 are recorded in the change instruction management table 17000 managed in the change instruction management section 3003 of the material management apparatus A and the change instructions 5100 and 5200 are acquired in the current processing of the change instruction synchronizing section 3007. On the other hand, the change instructions 5000, 5100, and 5200 are recorded in the change instruction management table 6000 managed in the change instruction management section of the material management apparatus B and the change instruction 17100 is acquired in the current processing of the change instruction synchronizing section 3007. Therefore, the number of change instructions of the change instructions recorded in the change instruction management table managed by the change instruction management section 3003 plus the change instruction acquired by performing the current processing of the change instruction synchronizing section 3007 retained in the material management apparatus A is the same as that retained in the material management apparatus B.

The method of transmitting and receiving the change instruction ID list and sending the change instruction request list specifying only the necessary change instructions has been used, but a method of transmitting all change instructions managed by the change instruction management section 3003 of the material management apparatus B to the material management apparatus A upon reception of a change instruction acquisition request and selecting only the necessary change instructions in the material management apparatus A is also available. That is, processing of acquiring the change instructions not managed in the change instruction management section 3003 of the home material management apparatus from another material management apparatus may be able to be performed and the details of the processing are not limited.

When the material management apparatus becomes online with another material management apparatus or when the change instruction management table managed by the change instruction management section 3003 changes in the material management apparatus online with another material management apparatus, the change instruction synchronizing section 3007 performs processing.

(2-6. Operation Example of Ignition Condition Information Processing Section)

The ignition condition information processing section 3008 determines the processing order about the change instructions received from the change instruction synchronizing section 3007 from the ignition condition information retained for each change instruction and the change instruction management table managed in the change instruction management section 3003, and transmits the change instructions to the conflict finding section 3009 according to the determined order.

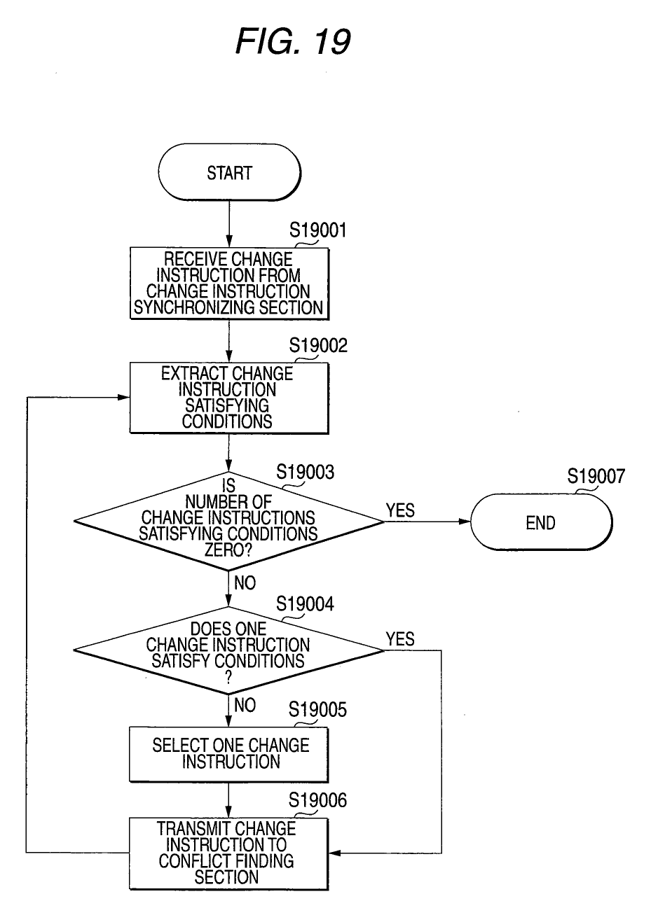

A processing flow of the ignition condition information processing section 3008 will be discussed with a flowchart of FIG. 19.

The ignition condition information processing section 3008 receives one or more change instructions from the change instruction synchronizing section 3007 (S19001).

A change instruction satisfying conditions is extracted from the ignition condition information retained by the change instruction received at S19001 and the change instruction management table managed by the change instruction management section 3003 (S19002). The conditions are the following three:

(1) Change instruction untransmitted from the ignition condition information processing section 3008 to the conflict finding section 3009. Whether or not the change instruction is untransmitted is determined using an already transmitted flag. It is determined that the change instruction given the already transmitted flag is an already transmitted change instruction and that the change instruction given no already transmitted flag is an untransmitted change instruction.

(2) When the apparatus ID is set to i, the number of change instructions recorded in the change instruction management table managed by the change instruction management section 3003 is counted for each material management apparatus issuing the change instruction and the value is set to “V(i)” for each apparatus ID. The value of “count” recorded in the ignition condition information is set to “W(i)” for each apparatus ID. At this time, change instruction satisfying “V(i)≧W(i)” in all apparatus IDs, namely, all “i.”

(3) Of the change instructions satisfying the conditions described above in (1) and (2), the change instruction with the minimum total of the instructions issued by each apparatus, recorded in the ignition condition information retained by the change instruction. In this case, specifically the change instruction with the minimum total of the values of “count” recorded in the ignition condition information. If two or more change instructions have the minimum total of the values of “count” exist, all are extracted.

If there is no change instruction extracted at S19002, the process goes to S19007; if one or more change instructions are extracted at S19002, the process goes to S19004 (S19003).

If one change instruction is extracted at S19002, the process goes to S19006; if two or more change instructions are extracted at S19002, the process goes to S19005 (S19004).

One is selected from the change instructions extracted at S19002 (S19005). The selection method at this time is arbitrary and a method of selecting the earlier extracted change instruction, etc., may be adopted.

The one change instruction extracted at S19002 or the change instruction selected at S19005 is transmitted to the conflict finding section 3009. After the change instruction is transmitted, an already transmitted flag is given to the change instruction and the process returns to S19002 (S19006).

The change instruction transmitted to the conflict finding section 3009 is managed in the change instruction management table of the change instruction management section 3003 as it is subjected to processing of the conflict finding section 3009 or the change instruction processing section 3006 or the conflict solution section 3010, etc., in some cases. After the change instruction management table is thus updated, the processing is continued at S19002.

The embodiment assumes the case where change instruction conflict occurs and therefore the change instruction is transmitted to the conflict finding section 3009; however, if it is guaranteed that no change instruction conflict occurs because of operation, etc., or if conflict is ignored, etc., the change instruction may be transmitted to the change instruction processing section 3006 without being transmitted to the conflict finding section 3009.

Next, a processing flow of the ignition condition information processing section 3008 of the material management apparatus A when the ignition condition information processing section 3008 receives the change instructions 5100 and 5200 shown in FIGS. 5 (b) and (c) from the change instruction synchronizing section 3007 in a state in which the change instruction management section 3003 of the material management apparatus A manages the change instructions 5000 and 17100 shown in FIG. 5 (a) and FIG. 17 (b) in the change instruction management table 17100 shown in FIG. 17 (a) will be discussed specifically.

The ignition condition information processing section 3008 receives the change instructions 5100 and 5200 from the change instruction synchronizing section 3007 (S19001).

A change instruction is extracted from the received change instructions according to the conditions (S19002).

(1) Both the change instructions 5100 and 5200 are untransmitted to the conflict finding section 3009.

(2) The count of the number of change instructions recorded in the change instruction management table 17000 managed by the change instruction management section 3003 for each apparatus ID is “V(A)=2” “V(B)=0” “V(C)=0” because two change instructions of the change instructions 5000 and 17100 are recorded under the column 17001 corresponding to the material ID A and no change instruction is recorded under the column 17002 or 17003. From the ignition condition information recorded in the cell 5106 of the change instruction 5100, “W(A)=1” “W(B)=0” “W(C)=0” results from “ID=A, count=1” “ID=B, count=0” “ID=C, count=0.” Therefore, as for the change instruction 5100, “V(i)≧W(i)” (i is A or B or C of the apparatus ID) holds in all apparatus IDs, and the condition is satisfied. From the ignition condition information recorded in the cell 5206 of the change instruction 5200, “W(A)=1” “W(B)=1” “W(C)=0” results from “ID=A, count=1” “ID=B, count=1” “ID=C, count=0.” Therefore, “V(B)<W(B)” in the apparatus ID B, and the condition is not satisfied.

(3) Only the change instruction 5100 is the change instruction satisfying both the conditions (1) and (2). Therefore, the change instruction 5100 is extracted.

Since only one change instruction 5100 is extracted at S19002, the process goes to S19004 (S19003).

Since only one change instruction 5100 is extracted at S19002, the process goes to S19006 (S19004).

The change instruction 5100 is transmitted to the conflict finding section 3009 (S19006). After this, an already transmitted flag is given to the change instruction 5100.

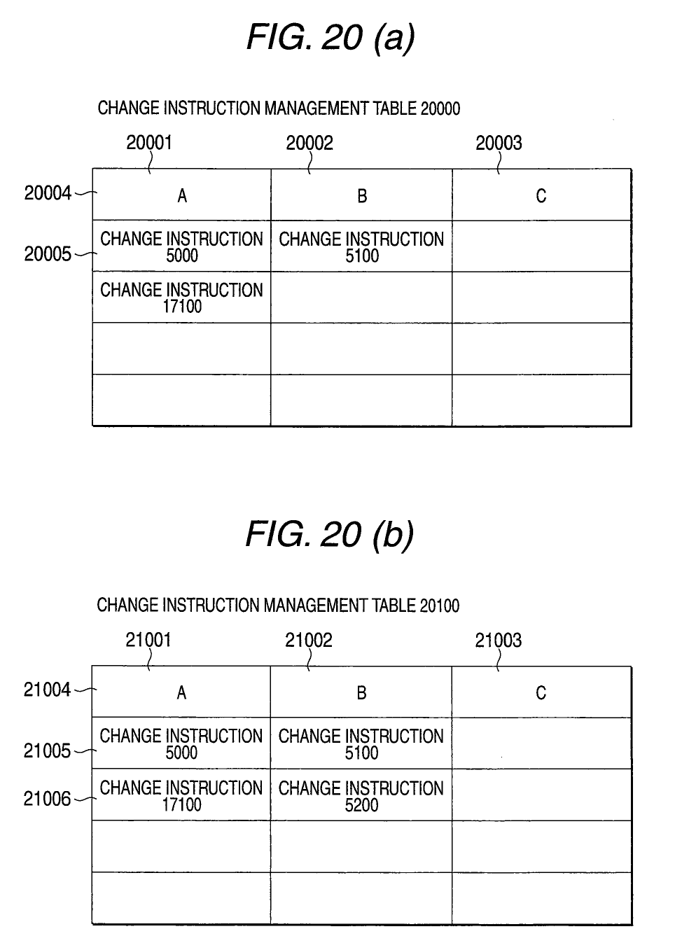

The change instruction 5100 transmitted to the conflict finding section 3009 is reflected on the change instruction management table 17000 of the change instruction management section 3003 as the conflict finding section 3009 or the change instruction processing section 3006 performs processing. As a result of reflecting the change instruction on the management table, the change instruction management table managed in the change instruction management section 3003 becomes a change instruction management table 20000 shown in FIG. 20 (a) from the change instruction management table 17000.

After a check is made to ensure that the change instruction 5100 transmitted to the conflict finding section 3009 at S19006 is recorded in the change instruction management table, the processing is continued at S19002.

(1) The change instruction 5200 is untransmitted to the conflict finding section 3009.

(2) The count of the number of change instructions recorded in the change instruction management table 20000 managed by the change instruction management section 3003 for each apparatus ID is “V(A)=2” “V(B)=1” “V(C)=0” because two change instructions of the change instructions 5000 and 17100 are recorded under the column 20001 corresponding to the material ID A, the change instruction 5100 is recorded under the column 20002 corresponding to the material ID B, and no change instruction is recorded under the column 20003 corresponding to the material ID C. From the ignition condition information recorded in the cell 5206 of the change instruction 5200, “W(A)=1” “W(B)=1” “W(C)=0” results from “ID=A, count=1” “ID=B, count=1” “ID=C, count=0.” Therefore, as for the change instruction 5200, “V(i)≧W(i)” (i is A or B or C of the apparatus ID) holds in all apparatus IDs, and the condition is satisfied.

(3) Only the change instruction 5200 is the change instruction satisfying both the conditions (1) and (2). Therefore, the change instruction 5200 is extracted.

Since only one change instruction 5200 is extracted at S19002, the process goes to S19004 (S19003).

Since only one change instruction 5200 is extracted at S19002, the process goes to S19006 (S19004).

The change instruction 5200 is transmitted to the conflict finding section 3009 (S19006). After this, an already transmitted flag is given to the change instruction 5200.

The change instruction 5200 transmitted to the conflict finding section 3009 is reflected on the change instruction management table 20000 of the change instruction management section 3003 as the conflict finding section 3009, the conflict solution section 3010, or the change instruction processing section 3006 performs processing. As a result of reflecting the change instruction on the management table, the change instruction management table managed in the change instruction management section 3003 becomes a change instruction management table 20100 shown in FIG. 20 (b) from the change instruction management table 20000.

After a check is made to ensure that the change instruction 5200 transmitted to the conflict finding section 3009 at S19006 is recorded in the change instruction management table, the processing is continued at S19002.

(1) There is no change instruction untransmitted to the conflict finding section 3009.

Therefore, the process goes to S19003 without extracting any change instruction.

Since no change instruction is extracted at S19002, the number of extracted change instructions is determined “0” and the process goes to S19007 (S19003).

The processing is terminated (S19007).

The described processing is performed, whereby it is made possible to perform processing observing the change instruction processing order.

The description has been given focusing attention on the material management apparatus A; also in the material management apparatus B, similar processing is performed for the change instruction received from the material management apparatus A.

(2-7. Operation Example of Conflict Finding Section)

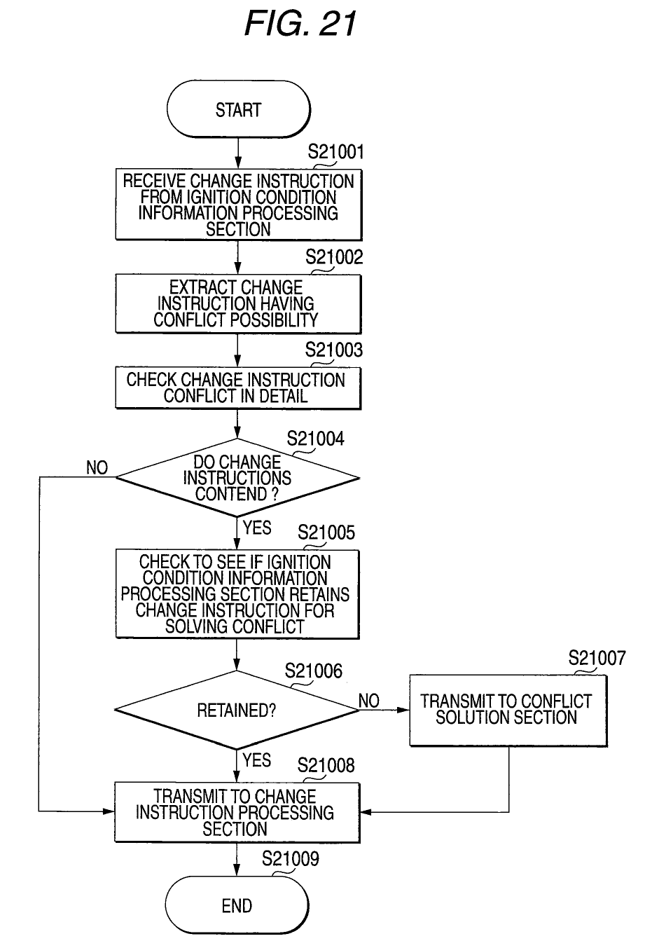

If conflict occurs between the change instruction received from the ignition condition information processing section 3008 and the change instruction recorded in the change instruction management table managed by the change instruction management section 3003, the conflict finding section 3009 finds the conflicting change instructions out of the change instruction management table and transmits the change instructions to the conflict solution section 3010. A processing flow of the conflict finding section 3009 will be discussed with a flowchart of FIG. 21.

The conflict finding section 3009 receives a change instruction from the ignition condition information processing section 3008 (S21001).

Using the ignition condition information recorded in the change instruction received at S21001, a change instruction requiring a conflict check is extracted from the change instructions recorded in the change instruction management table managed in the change instruction management section 3003 (S21002). A specific extraction method of a change instruction requiring a conflict check is as follows: First, when the apparatus ID is i, the number of change instructions recorded in the change instruction management table managed by the change instruction management section 3003 is counted for each material management apparatus issuing the change instruction and the value is set to “V(i)” for each apparatus ID. The value of “count” recorded in the ignition condition information retained in the change instruction received at S21001 is set to “W(i)” for each apparatus ID. “V(i)−W(i)” change instructions are extracted from the change instruction management table in the order, namely, the descending order of the serial numbers from the apparatus ID “i.” The conflict finding section 3009 does not receive any change instruction having ignition condition information as the value of “V(i)−W(i)” becomes minus by processing of the ignition condition information processing section 3008.

A comparison is made between all change instructions extracted from the change instruction management table at S21002 and the change instruction received from the ignition condition information processing section 3008 at S21001 to check whether or not the change instructions contend (S21003). Specifically, the information recorded in the entry of “processing target” of one change instruction extracted at S21002 and that of the change instruction received at S21001 (for example, “title,” “photographer name,” etc.,) are identical. If the processing targets of the change instructions are identical, it is determined that the change instructions contend; if the processing targets of the change instructions are not identical, it is not determined that the change instructions contend. If no instruction is extracted at S21002, it is determined that conflicting change instructions do not exist.

If it is determined at S21003that one change instruction extracted at S21002 contends with the change instruction received at S21001, the process goes to S21005; if none of the change instructions extracted at S21002 contend with the change instruction received at S21001, the process goes to S21008 (S21004).

If it is determined at S21004 that one change instruction extracted at S21002 contends with the change instruction received at S21001, a check is made to see if a change instruction for solving the conflict between the change instruction received at S21001 and the change instruction extracted at S21003 by the conflict finding section 3009 exists in the change instructions received by the ignition condition information processing section 3008 from the change instruction synchronizing section 3007 and retained by the ignition condition information processing section 3008 (S21005). The change instruction for solving the conflict refers to the change instruction involving the same processing target as the conflicting change instruction, issued in a state in which all change instructions having the conflict relationship are managed in the change instruction management table. In this case, whether or not the change instruction is issued in a state in which all change instructions having the conflict relationship are managed in the change instruction management table using the “ignition condition information,” and whether or not the change instruction involves the same processing target as the conflicting change instruction is determined on the entry of “processing target” of each of the change instructions. Letting the apparatus ID of the change instructions having the conflict relationship be “i,” the serial number be “n,” and the value of “count” of the change instruction ignition condition information retained by the ignition condition information processing section 3008 be “W(i),” the change instruction having the ignition condition information where “n≦W(i)” holds in all change instructions having the conflict relationship and involving the same entry of “processing target” as the change instruction having the conflict relationship is the change instruction for solving the conflict.

If it can be checked at S21005 that the change instruction for solving the conflict exists for every conflict between the change instruction received at S21001 and the change instruction extracted at S21003, the process goes to S21008; if one change instruction for solving the conflict cannot be found, the process goes to S21007 (S21006).

If a change instruction for solving the conflict between the change instruction received at S21001 and the change instruction extracted at S21003 cannot be found at S21005, the change instruction received at S21001 and the change instruction extracted at S21003having the conflict relationship for which the change instruction for solving the conflict therebetween cannot be found are transmitted to the conflict solution section 3010 (S21007).

The change instruction received at S21001 is transmitted to the change instruction processing section 3006 (S21008).

The processing is terminated (S21009).

(One Example of Processing when Conflict Occurs)

Next, a processing flow of the conflict finding section 3009 when the conflict finding section 3009 receives the change instruction 5100 as the ignition condition information processing section 3008 receives the change instructions 5100 and 5200 shown in FIGS. 5 (b) and (c) from the change instruction synchronizing section 3007 and performs processing in a state in which the change instruction management section 3003 of the material management apparatus A records the change instructions 5000 and 17100 shown in FIG. 5 (a) and FIG. 17 (b) in the change instruction management table 17100 shown in FIG. 17 (a) will be discussed specifically.

The conflict finding section 3009 of the material management apparatus A receives the change instruction 5100 from the ignition condition information processing section 3008 (S21001).

A change instruction having a possibility of conflicting with the change instruction 5100 is extracted from the change instructions recorded in the change instruction management table 17000 managed by the change instruction management section 3003 (S21002). “V(A)=2” “V(B)=0” “V(C)=0” according to the change instruction management table 17000. From the ignition condition information recorded in the cell 5106 of the change instruction 5100 received at S21001, “W(A)=1” “W(B)=0” “W(C)=0” results from “ID=A, count=1” “ID=B, count=0” “ID=C, count=0.” Therefore, “V(A)−W(A)=1” “V(B)−W(B)=0” “V(C)−W(C)=0.” Thus, one change instruction 17100 of a change instruction having the value of the serial number larger than the change instruction 5000 is extracted from the column 17001 of the material management table 17000 corresponding to the apparatus ID “A.”

Whether or not the change instruction 5100 received at S21001 and the change instruction 17100 extracted at S21002 contend with each other is checked (S21003). Since the processing target “photographer name” recorded in the cell 5104 of the change instruction 5100 and the processing target “photographer name” recorded in the cell 17104 of the change instruction 17100 are identical, it is determined that the change instructions contend with each other.

Since it is determined at S21003that the change instructions contend with each other, the process goes to S21005 (S21004).

A check is made to see if a change instruction for solving the conflict between the change instructions 5100 and 17100 exists in the change instructions received by the ignition condition information processing section 3008 from the change instruction synchronizing section 3007 (S21005). At this time, the change instruction retained by the ignition condition information processing section 3008 is only the change instruction 5200, and the ignition condition information recorded in the cell 5206 of the change instruction 5200 becomes “W(A)=1” “W(B)=1” “W(C)=0” from “ID=A, count=1” “ID=B, count=1” “ID=C, count=0.” The apparatus IDs and the serial numbers of the change instructions 5100 and 17100 having the conflict relationship are “apparatus ID=B, serial number=1” and “apparatus ID=A, serial number=2.” Therefore, when the apparatus ID is A, the serial number is 2 and “n≦W(A)” is not satisfied. The processing target recorded in the cell 5204 of the change instruction 5200 is “title” and differs from the processing targets “photographer name” of the change instructions 5100 and 17100. Therefore, it is determined that there is no change instruction for solving the conflict.

Since it is determined at S21005 that there is no change instruction for solving the conflict, the process goes to S21007 (S21006).

The change instruction 5100 received at S21001 and the change instruction 17100 managed in the change instruction management table 17000 managed by the change instruction management section 3003 are transmitted to the conflict solution section 3010 (S21007).

The change instruction 5100 received at S21001 is transmitted to the change instruction processing section 3006 (S21008). The change instruction 5100 is transmitted to the conflict solution section 3010 at S21007, but, here, it is also transmitted to the change instruction processing section 3006.

The processing is terminated (S21009).

The processing is thus performed using the ignition condition information, whereby change instruction conflict can be found and an occasion in which the conflict can be solved in the conflict solution section 3010 can be provided.

(One Example of Processing when No Conflict Occurs)

Next, a processing flow of the conflict finding section 3009 when the conflict finding section 3009 receives the change instruction 5200 as the ignition condition information processing section 3008 performs processing in a state in which the conflict finding section 3009 receives the change instruction 5100 and performs processing and the change instruction management section 3003 records the change instructions 5000, 5100, and 17100 shown in FIGS. 5 (a) and (b) and FIG. 17 (b) in the change instruction management table 20000 shown in FIG. 20 (a) as the ignition condition information processing section 3008 receives the change instructions 5100 and 5200 shown in FIGS. 5 (b) and (c) from the change instruction synchronizing section 3007 and performs processing in a state in which the change instruction management section 3003 of the material management apparatus A records the change instructions 5000 and 17100 shown in FIG. 5 (a) and FIG. 17 (b) in the change instruction management table 17100 shown in FIG. 17 (a) will be discussed specifically.

The conflict finding section 3009 of the material management apparatus A receives the change instruction 5200 from the ignition condition information processing section 3008 (S21001).

A change instruction having a possibility of conflicting with the change instruction 5200 is extracted from the change instructions recorded in the change instruction management table 20000 managed by the change instruction management section 3003 (S21002). “V(A)=2” “V(B)=1” “V(C)=0” according to the change instruction management table 20000. From the ignition condition information recorded in the cell 5206 of the change instruction 5200 received at S21001, “W(A)=1” “W(B)=1” “W(C)=0” results from “ID=A, count=1” “ID=B, count=1” “ID=C, count=0.” Therefore, “V(A)−W(A)=1” “V(B)−W(B)=0” “V(C)−W(C)=0.” Thus, one change instruction 17100 of a change instruction having the value of the serial number larger than the change instruction 5000 is extracted from the column 20001 of the material management table 20000 corresponding to the apparatus ID “A.”

Whether or not the change instruction 5200 received at S21001 and the change instruction 17100 extracted at S21002 contend with each other is checked (S21003). Since the processing target “title” recorded in the cell 5204 of the change instruction 5200 and the processing target “photographer name” recorded in the cell 17104 of the change instruction 17100 differ, it is determined that the change instructions do not contend with each other.

Since it is determined at S21003that the change instructions do not contend with each other, the process goes to S21008 (S21004).

The change instruction 5200 received at S21001 is transmitted to the change instruction processing section 3006 (S21008).

The processing is terminated (S21009).

(One Example of Processing when Change Instruction for Solving Conflict Exists)

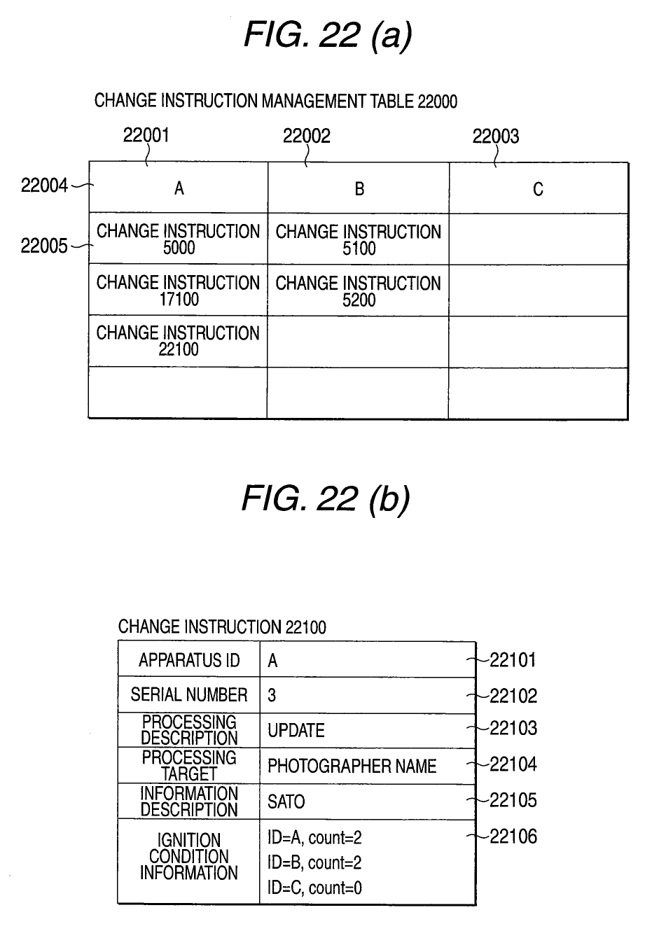

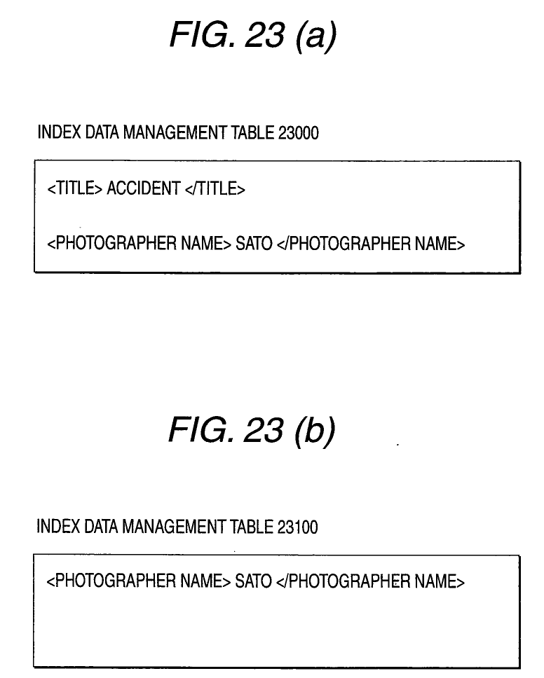

Next, processing when the material management apparatus A becomes online with the material management apparatus C managing no change instructions in the change instruction management table managed in the change instruction management section 3003 in a state in which the change instruction management section 3003 of the material management apparatus A records the change instructions 5000, 5100, 5200, and 17100 and a change instruction 22000 shown in FIG. 22 (b) in a change instruction management table 22000 shown in FIG. 22 (a) and the change instruction synchronizing section 3007 of the material management apparatus C acquires the change instructions 5000, 5100, 5200, 17100, and 22000 from the material management apparatus A and transmits the change instructions to the ignition condition information processing section 3008 will be discussed. At this time, the index data management table managed by the data management section 3002 of the material management apparatus A is placed in the state of an index data management table 23100.

The processing of the ignition condition information processing section 3008 previously described is performed, whereby first the change instruction 5000 is transmitted to the conflict finding section 3009. Since the change instruction management section 3003 of the material management apparatus C does not record a conflicting change instruction, the change instruction is passed to the change instruction processing section 3006 and is recorded in the change instruction management table, which then becomes the state of the change instruction management table 14000. The index data management table managed by the data management section 3002 is in the state of the index data management table 13000.

The change instructions 5100 and 17100 are extracted at S19002 of the processing flowchart of the ignition condition information processing section 3008. At this time, it is assumed that the change instruction 5100 is selected and is transmitted to the conflict finding section 3009 at S19005. If the change instruction 17100 is selected, the processing does not much differ. Since a conflicting change instruction is not recorded in the index data management table managed by the change instruction management section 3003 of the material management apparatus C, the change instruction is passed to the change instruction processing section 3006 and is recorded in the change instruction management table, which then becomes the state of the change instruction management table 14100. The index data management table managed by the data management section 3002 is in the state of the index data management table 4000.

The change instruction 17100 is transmitted from the ignition condition information processing section 3008 to the conflict finding section 3009. At this time, it is determined at S21004 of the processing flowchart of the conflict finding section 3009 that the change instruction 5100 contends with the change instruction 17100.

A check is made to see if a change instruction for solving the conflict between the change instructions 5100 and 17100 exists in the change instructions received by the ignition condition information processing section 3008 from the change instruction synchronizing section 3007 (S21005). At this time, the change instructions retained by the ignition condition information processing section 3008 are the change instructions 5200 and 22100, and the ignition condition information recorded in the cell 5206 of the change instruction 5200 becomes “W(A)=1” “W(B)=1” “W(C)=0” from “ID=A, count=1” “ID=B, count=1” “ID=C, count=0.” The apparatus IDs and the serial numbers of the change instructions 5100 and 17100 having the conflict relationship are “apparatus ID=B, serial number=1” and “apparatus ID=A, serial number=2.” Therefore, when the apparatus ID is A, the serial number is 2 and “n≦W(A)” is not satisfied. The processing target recorded in the cell 5204 of the change instruction 5200 is “title” and differs from the processing targets “photographer name” of the change instructions 5100 and 17100. Next, the ignition condition information recorded in a cell 22106 of the change instruction 22100 becomes “W(A)=2” “W(B)=2” “W(C)=0” from “ID=A, count=2” “ID=B, count=2” “ID=C, count=0.” Therefore, “n≦W(i)” holds in all apparatus IDs “i.” Thus, it is determined that the change instruction 22100 exists as a change instruction for solving the conflict.

Since it can be checked at S21005 that a change instruction for solving the conflict exists, the change instruction 17100 is transmitted to the change instruction processing section 3006 at S21008 and the processing of the conflict finding section 3009 is terminated.

The described processing in the material management apparatus C is put in order and the state of the change instruction management table and the index data management table at each processing point in time will be discussed.

The change instruction processing section 3006 records the change instruction 17100 in the change instruction management table, which then becomes the state of the change instruction management table 20000. The index data management table managed by the data management section 3002 is in the state of the index data management table 23000.

The change instruction 17100 is transmitted from the ignition condition information processing section 3008 to the conflict finding section 3009. The conflict finding section 3009 does not find conflict. The change instruction is transmitted to the change instruction processing section 3006 and is recorded in the change instruction management table, which then becomes the state of the change instruction management table 20100. The index data management table managed by the data management section 3002 is in the state of the index data management table 23100.

Last, the change instruction 22100 is transmitted from the ignition condition information processing section 3008 to the conflict finding section 3009. The conflict finding section 3009 does not find conflict. The change instruction is transmitted to the change instruction processing section 3006 and is recorded in the change instruction management table, which then becomes the state of the change instruction management table 22000. The index data management table managed by the data management section 3002 is in the state of the index data management table 23100.

Thus, the processing is performed in the material management apparatus C using the change instruction 22100 for solving the conflict generated in the material management apparatus A and the ignition condition information, whereby appropriate change instruction synchronization can be performed without again performing conflict solving processing and index data synchronization can be executed by performing application processing of the change instructions to the index data.

(2-8. Operation Example of Conflict Solution Section)

The conflict solution section 3010 presents the conflicting change instructions received from the conflict finding section 3009 to the user and requests the user to select one of the change instructions for solving the conflict and the result is managed in the change instruction management section 3003 as a new change instruction. Thus, the conflict solution section 3010 transmits the selection result of the user to the change instruction generation section 3004 as change information and the change instruction generation section 3004 generates a change instruction and the change instruction processing section 3006 processes the change instruction, whereby the change instruction is reflected on the data management section 3002 and the change instruction management section 3003. In this case, information concerning the conflicting change instructions is presented to the user and requests the user to select one of the change instructions for solving the conflict. However, the solution method is not the prime purpose of the invention and various methods such as a method of performing automatic processing according to some rule are possible. The prime purpose of the invention is to appropriately manage the solution result based on the user's selection or according to some rule and appropriately transmit the solution result so as to eliminate the need for again performing the same conflict solution processing when another material management apparatus receives the conflicting change instructions.

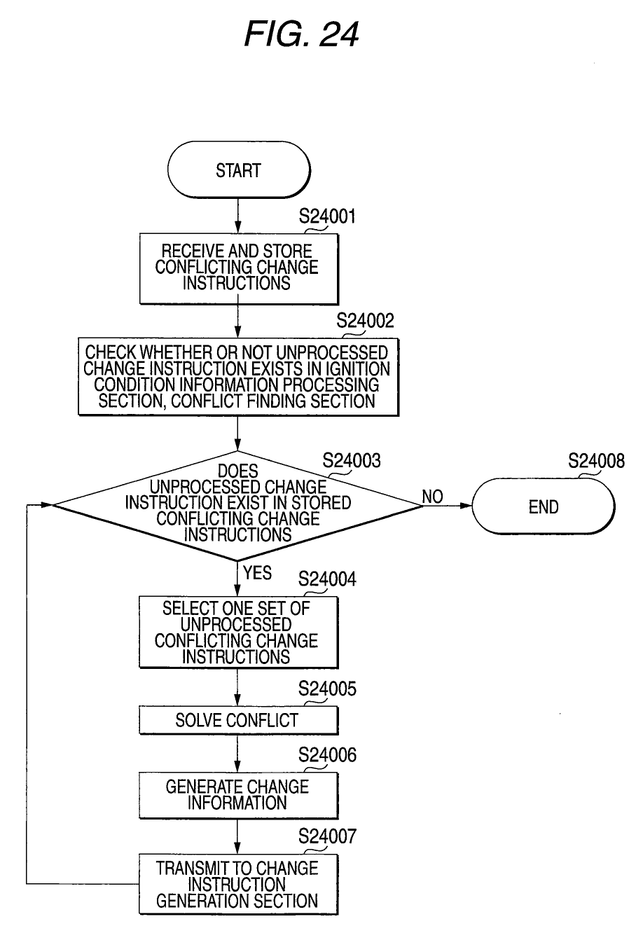

A processing flow of the conflict solution section 3010 will be discussed with a flowchart of FIG. 24.

The conflicting change instructions are received from the conflict finding section 3009 (S24001). At this time, two or more change instructions having the conflict relationship are received at the same time.

Whether or not an unprocessed change instruction exists in the ignition condition information processing section 3008 and the conflict finding section 3009 is checked (S24002). While an unprocessed change instruction exists, conflicting change instructions are received and are stored at S24001. If an unprocessed change instruction runs out in the ignition condition information processing section 3008 and the conflict finding section 3009, the process goes to S24003.

Whether an unprocessed change instruction exists in the conflicting change instructions stored at S24001 is determined (S24003). If an unprocessed change instruction exists, the process goes to S24004; if an unprocessed change instruction does not exist, the process goes to S24008.

A set of two or more unprocessed change instructions having the conflict relationship stored at S24001 is selected (S24004).

The two or more change instructions having the conflict relationship selected at S24004 is presented to the user and entry of the selection result is received (S24005).

Change information is generated from the selected change instruction according to the entry at S24005 (S24006).

The change information generated at S24006 is transmitted to the change instruction generation section 3004 (S24007).

If it is determined at S24003 that an unprocessed change instruction having the conflict relationship does not exist, the processing is terminated (S24008).

The described processing is performed, whereby the instruction for solving the solution is generated in the change instruction generation section 3004 and is reflected on the data management section 3002 and the change instruction management section 3003 by the change instruction processing section 3006.

Next, a processing flow of the conflict solution section 3010 when the conflict solution section 3010 receives the change instruction 5100 shown in FIG. 5 (b) and the change instruction 17100 shown in FIG. 17 (b) as conflicting instructions from the conflict finding section 3009 will be discussed.

The conflicting change instructions 5100 and 17100 are received from the conflict finding section 3009 (S24001).

A check is made to see if an unprocessed change instruction exists in the ignition condition information processing section 3008 and the conflict finding section 3009 (S24002). In this case, it is assumed that the change instructions having the conflict relationship, received by the conflict solution section 3010 until completion of the processing of the conflict finding section 3009 are only the change instructions 5100 and 17100.

Since the change instructions 5100 and 17100 having the conflict relationship are unprocessed, the process goes to S24004 (S24003).

A set of the change instructions 5100 and 17100 is selected as unprocessed change instructions having the conflict relationship (S24004).

Information on the change instructions 5100 and 17100 is presented to the user and entry is received, whereby the conflict is solved (S24005). Specifically, information of “photographer name” and “YAMADA” recorded in the cells 5104 and 5105 of the change instruction 5100 and information of “photographer name” and “SATO” recorded in the cells 17104 and 17105 of the change instruction 17100 are presented to the user using a display and entry of the user as to which information is to be adopted or entry of different information is received using an input unit. Here, it is assumed that the information of “SATO” is selected according to entry of the user.

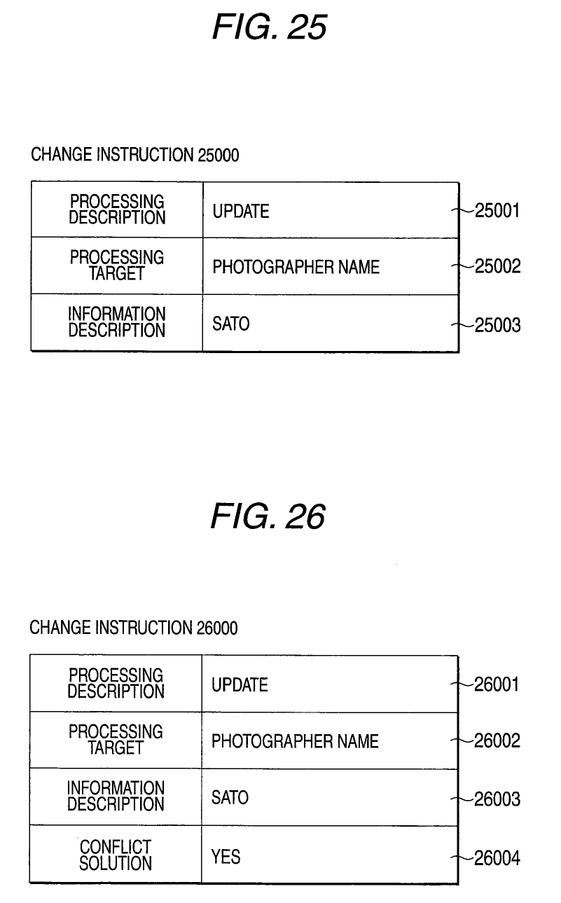

Change information is generated based on the information selected at S24005 (S24006). The information description of change information is set to “SATO,” the conflicting processing target is set to “photographer name,” and the processing description is set to “update” according to the entry result of the user at S24005 to generate change information. The change information created at this time is shown in change information 25000 in FIG. 25. The information description of “SATO” selected by the user is recorded in 25003, the information of “photographer name” of the conflicting processing target is recorded in a cell 25002, and “update” indicating the processing description is recorded in a cell 25001.

The change information 25000 generated at S24006 is transmitted to the change instruction generation section 3004 (S24007).

It is determined at S24003 that an unprocessed change instruction having the conflict relationship does not exist, and the process goes to S24008.

The processing is terminated (S24008).

The change information 25000 transmitted to the change instruction generation section 3004 is processed by the change instruction generation section 3004, whereby the change instruction 22100 shown in FIG. 22 (b) of a change instruction for solving the conflict is generated and is processed by the change instruction processing section 3006, whereby the change instruction management table retained by the change instruction management section 3003 becomes the state of the change instruction management table 22000 shown in FIG. 22 (a) from the state of the change instruction management table 20100 shown in FIG. 22 (b). The index data management table managed by the data management section 3002 is in the state of the index data management table 23100.

### Second Embodiment

In a second embodiment, another example of the conflict solution section of the first embodiment is disclosed. The parts other than the conflict solution section are similar to those of the first embodiment and therefore will not be discussed again.

(Operation Example of Conflict Solution Section)

A conflict solution section 3010 presents the conflicting change instructions received from a conflict finding section 3009 to the user and requests the user to select one of the change instructions for solving the conflict and the result is managed in a change instruction management section 3003 as a new change instruction. Thus, the conflict solution section 3010 transmits the selection result of the user to a change instruction generation section 3004 as change information and the change instruction generation section 3004 generates a change instruction and a change instruction processing section 3006 processes the change instruction, whereby the change instruction is reflected on a data management section 3002 and the change instruction management section 3003.

The processing flow of the conflict solution section 3010 is as shown in the flowchart of FIG. 24 and is similar to that described in the first embodiment and therefore will not be discussed again.

Next, a processing flow of the conflict solution section 3010 when the conflict solution section 3010 receives the change instruction 5100 shown in FIG. 5 (b) and the change instruction 17100 shown in FIG. 17 (b) as conflicting instructions from the conflict finding section 3009 will be discussed.

The conflicting change instructions 5100 and 17100 are received from the conflict finding section 3009 (S24001).

A check is made to see if an unprocessed change instruction exists in an ignition condition information processing section 3008 and the conflict finding section 3009 (S24002). In this case, it is assumed that the change instructions having the conflict relationship, received by the conflict solution section 3010 until completion of the processing of the conflict finding section 3009 are only the change instructions 5100 and 17100.

Since the change instructions 5100 and 17100 having the conflict relationship are unprocessed, the process goes to S24004 (S24003).

A set of the change instructions 5100 and 17100 is selected as unprocessed change instructions having the conflict relationship (S24004).

Information on the change instructions 5100 and 17100 is presented to the user and entry is received, whereby the conflict is solved (S24005). Specifically, information of “photographer name” and “YAMADA” recorded in the cells 5104 and 5105 of the change instruction 5100 and information of “photographer name” and “SATO” recorded in the cells 17104 and 17105 of the change instruction 17100 are presented to the user using a display and entry of the user as to which information is to be adopted or entry of different information is received using an input unit. Here, it is assumed that the information of “SATO” is selected according to entry of the user.

Change information is generated based on the information selected at S24005 (S24006). The information description of change information is set to “SATO,” the conflicting processing target is set to “photographer name,” and the processing description is set to “update” according to the entry result of the user at S24005 to generate change information. The change information created at this time is shown in change information 26000 in FIG. 26. The information description of “SATO” selected by the user is recorded in 26003, the information of “photographer name” of the conflicting processing target is recorded in a cell 26002, “update” indicating the processing description is recorded in a cell 26001, and information representing conflict solution information is recorded in a cell 26004. In the embodiment, conflict solution information is represented by providing a cell of “conflict resolution” in the change information and recording YES in the cell or NO if conflict solution information is not applied, but the method is not limited to the method. A binary flag may be used to represent conflict solution according to one value and represent no conflict solution information according to the other value.

The change information 26000 generated at S24006 is transmitted to the change instruction generation section 3004 (S24007).

It is determined at S24003 that an unprocessed change instruction having the conflict relationship does not exist, and the process goes to S24008.

The processing is terminated (S24008).

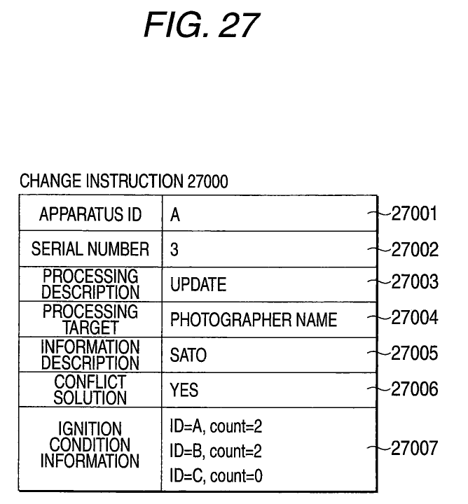

The change information 26000 transmitted to the change instruction generation section 3004 is processed by the change instruction generation section 3004, whereby the change instruction for solving the conflict is generated and is processed by the change instruction processing section 3006, whereby a change instruction management table retained by the change instruction management section 3003 is updated. An index data management table managed by the data management section 3002 is also updated. FIG. 27 shows an example of the change instruction generated by processing of the change instruction generation section 3004.

The information indicating that the change instruction is a change instruction for solving the conflict can be used for extracting only the change instruction for solving the conflict when different processing is performed or the like.

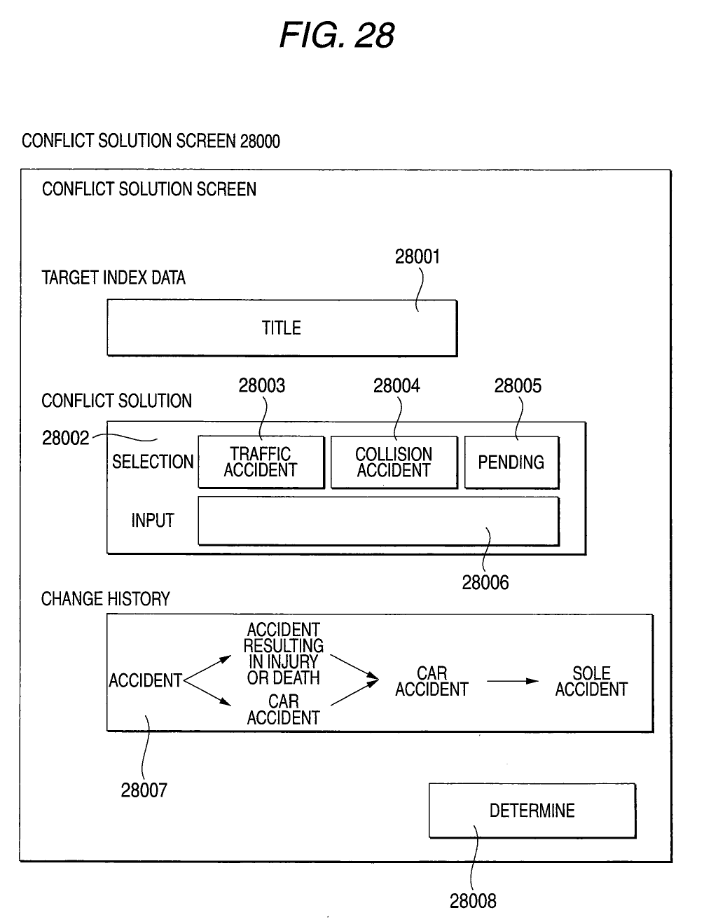

FIG. 28 shows a screen example for the user to select change instructions having the conflict relationship at S24005 in FIG. 24.

A box 28001 represents the index data to which the current conflict solution screen applies. FIG. 28 represents that the target index data is “title.”

A box 28002 is a box for solving the conflict. For a conflict solution method, means for selecting either of conflict information pieces, pending without solving the conflict this time, or entering different information from the conflict information for solving the conflict is provided. In 28003 and 28004 in FIG. 28, the current conflict information pieces are displayed like buttons and either button is pressed, whereby the entry is selected. In this case, information of “traffic accident” and information of “collision accident” contend with each other and either can be selected. To set a pending state without solving the conflict, a pending button in 28005 is pressed. A box 28006 is a box wherein information is entered by directly entering some information for solving the conflict. The conflict solving buttons 28003 and 28004, the conflict solution pending button 28005, and the box 28006 for directly entering information can be selected exclusively; any one of the buttons 28003, 28004, 28005 can be selected and if any button is selected, information cannot be entered in the box 28006. If information is entered in the box 28006, none of the buttons 28003, 28004, and 28005 can be selected.

A box 28007 displays a change history of the target index data written in the box 28001. The part where branch occurs at midpoint in the box 28007 and then the arrows merge represents that information conflict occurs and is solved. Specifically, in the example in FIG. 28, the result of rewriting “accident” as “accident resulting in injury or death” and “car accident” is found as conflict and the conflict is solved by selecting information of “car accident.” Then, the information is changed from “car accident” to “sole accident.” The change history can be generated from the change information. It is made possible for the user to easily determine conflict solution by referencing the change information.

The button selection or entry result in the box 28002 is confirmed as a button 28008 is pressed.

If pending is selected without solving the conflict, steps S24006 and S24007 in FIG. 24 are skipped and the process returns from S24005 to S24003.

The conflict can also be solved in an offline state. In this case, when the apparatus become online, change instructions are transmitted and received for synchronization and solution of once found conflict is made pending in accordance with selection of the user or preset information. Then, it is made possible to perform conflict finding processing in an offline state and perform solution processing for the found conflicting change instructions.

### Third Embodiment

In a third embodiment, an index data synchronizing method of material in a material management apparatus used for program production is disclosed. Here, a moving image in MPEG-2 format is considered as the material and the title and the photographer name of the moving image and manipulation performed on the moving image are considered as the index data. The manipulation performed on the moving image can be deletion, editing, etc., of the moving image. The description method of deletion and edition is not the prime purpose of the invention and therefore will not be discussed in detail. A play list, an EDL (Edit Decision List), etc., used with an editing machine, etc., can be used. In the invention, the case where deletion manipulation is synchronized as index data will be discussed.

The material is not limited to the moving image in the MPEG-2 format and a moving image in any other format such as DV or only audio may be adopted. The index data is not limited to the title, the photographer name, or the manipulation performed on the material; text information of the photographing date and time, the photographing location, the program name, the moving image management location (information for identifying the apparatus managing the material and the management location in the apparatus), etc., and various pieces of additional information concerning material such as a representative still image of a moving image recorded in a BMP or JPEG format are possible. For example, the photographing date and time, the photographing location, the program name, the representative still image, and the like are synchronized between the material management apparatus, whereby it is made possible to know detailed information concerning the material managed by a different material management apparatus and it is made possible to determine whether or not the material is required without acquiring the material. The location information is synchronized between the material management apparatus as the index data, whereby it is made possible to acquire the material managed by a different material management apparatus.

The material management apparatus of the invention arbitrarily makes a transition to an online state or an offline state with a different material management apparatus, and the index data is updated regardless of the offline state or the online state. A method of synchronizing the index data in such material management apparatus is disclosed in the embodiment.

(1. General Configuration)

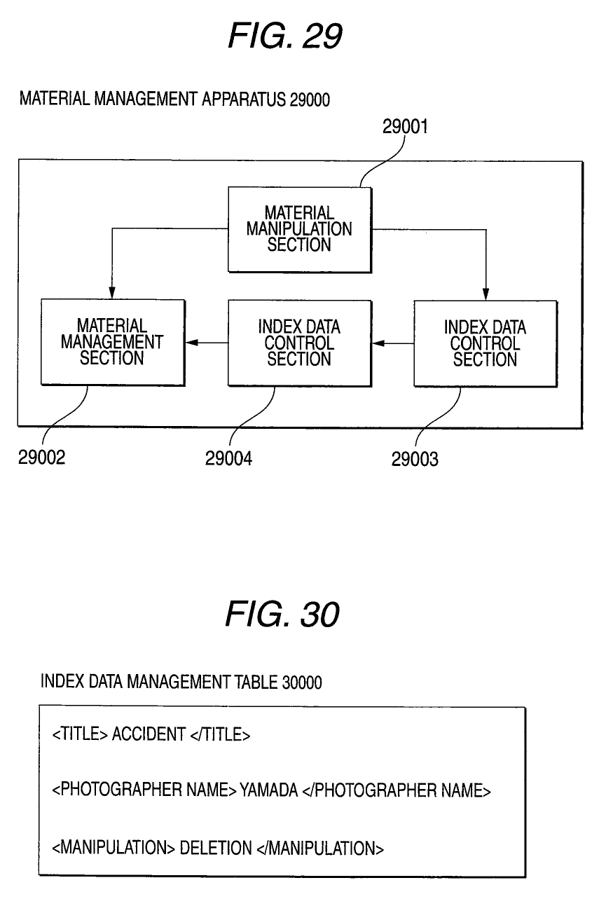

FIG. 29 shows the general configuration of the material management apparatus in the embodiment. A material management apparatus 29000 is made up of a material manipulation section 29001, a material management section 29002, an index data control section 29003, and an index data processing section 29004. The material manipulation section 29001 registers, changes, and deletes material in the material management section 29002, and notifies the index data control section 29003 of index data change accompanying the registration, the change, or the deletion. To change only the index data without changing the material, the change description is sent from the material manipulation section 29001 to the index data control section 29003. The material management section 29002 manages the material received from the material manipulation section 29001. The index data control section 29003 performs new creation, update, or deletion of index data sent from the material manipulation section 29001 for the retained index data. It synchronizes the index data when the material management apparatus becomes online with a different material management apparatus. If information of “manipulation” on the material is recorded in the index data synchronized by the index data control section 29003, the index data processing section 29004 performs the processing described in “manipulation” on the material retained in the material management section 29002 based on the information. The manipulation is “deletion” described in the part sandwiched between “<manipulation>” and “</manipulation>” in an index data management table 30000 shown in FIG. 30. If the information of the manipulation is information sent to the index data control section 29003 by the material manipulation section 29001 of the home material management apparatus, the index data processing section 29004 does not perform the processing for the material management section; however, if the information is information synchronized from another apparatus, the index data processing section 29004 performs the processing described in the manipulation for the material management section 29002. For “deletion” of the manipulation retained in the index data management table in FIG. 30, the index data processing section 29004 performs processing of deleting the corresponding material retained in the material management section 29002.

The index data control section of a component as the processing nucleus of data synchronization is the same as that of the first or second embodiment and therefore will not be discussed again in detail.

### Other Embodiments

In the described embodiments, the index data of the information concerning material is synchronized, but the material may be synchronized using the system. A moving image, a still image, audio, text information, or the like is possible as the material.

In addition to material management for the program production purpose described in the embodiment, in a home network, information of content recorded and managed in each machine may be synchronized using the system or the content may be synchronized using the invention. The index of content or the content in a home network is synchronized in a situation in which a machine which frequently becomes offline from the home network, such as a portable machine exists, whereby if the user carries a portable machine back to the home and connects the portable machine to the home network without concern for which content is managed in which machine, it is made possible to use the content managed in the machine connected to the home network. It is also made possible to use newly registered content in the portable machine when the portable machine is offline from a machine connected to the home network.

The number of the change instructions recorded in the change instruction management table managed in the change instruction management section, counted for each apparatus issuing the change instruction is used as the ignition condition information, but an identifier capable of uniquely identifying each change instruction can be given to the change instruction and a list of all identifiers of the change instructions recorded in the change instruction management table can also used as the ignition condition information. At this time, the ignition condition information processing section can count the number of the identifiers recorded as the ignition condition information, thereby performing similar processing to that of the first embodiment. Similar comments apply to the conflict finding section.

Considering text information as the material, for two or more persons to create the same Web page in cooperation, it is made possible to detect whether or not description conflict occurs among the Web pages created by the persons and provide an occasion for solving the conflict if conflict can be detected.

In the first embodiment, conflict is solved in the apparatus issuing a change instruction acquisition request early. However, priorities can be determined among the apparatus and for the apparatus having high priority and low priority to perform synchronization processing, they can transmit mutual priority to each other and the apparatus having high priority can first issue a change instruction acquisition request, whereby the apparatus having high priority can be caused to solve the conflict. If the apparatus having low priority issues a change instruction acquisition request, conflict solution can be made pending and the apparatus having high priority can be caused to solve the conflict.

While the invention has been described in detail with reference to the specific embodiments, it will be obvious to those skilled in the art that various changes and modifications can be made without departing from the spirit and the scope of the invention.

This application is based on Japanese Patent Application (No. 2005-291521) filed on Oct. 4, 2005, which is incorporated herein by reference.

### INDUSTRIAL APPLICABILITY

The invention can be applied not only to the material management apparatus for managing video material photographed and edited for program production, but also to the use mode wherein various machines for storing and playing back content, such as an audio player, a DVD recorder, a portable audio player, a portable video player, and a mobile telephone capable of playing back audio and video are connected in a network such as a home network, information of content managed in another machine is acquired, the content to be used is acquired, and the content is synchronized among the machines.

1. An information processing apparatus for making a transition at any desired timing to a state in which the apparatus can communicate with a different information processing apparatus or a state in which the apparatus cannot communicate with a different information processing apparatus, wherein information is newly registered in the information processing apparatus or information managed by the information processing apparatus is updated or deleted regardless of the communication-possible state or the communication-impossible state, the information processing apparatus comprising:
a data management unit that manages information;
a change instruction generation unit that generates change description of the information managed by the data management unit as a change instruction;
a change instruction record unit for recording that records a change instruction acquired from the different information processing apparatus and the generated change instruction in a state in which information processing apparatuses which generate the respective change instructions is generated can be determined; and
a change instruction synchronizing unit for acquiring that acquires a change instruction not recorded in the change instruction record unit from the different information processing apparatus by transmitting and receiving change instructions to and from the different information processing apparatus.

2. The information processing apparatus according to claim 1, wherein
in the change instruction generation unit, apparatus identification information of the information processing apparatus and serial number generated for each apparatus by incrementing the value each time a change instruction is given are recorded in the change instruction together with the change description of the information managed by the data management unit.

3. The information processing apparatus according to claim 1, wherein
the information processing apparatus comprises an ignition condition information processing unit for generating ignition condition information counting the number of the change instructions managed in the change instruction management unit when a change instruction is generated in the change instruction generation unit for each information processing apparatus generating the change instruction, and
the ignition condition information is further recorded in the change instruction in the change instruction generation unit.

4. The information processing apparatus according to claim 1, wherein
an identifier for uniquely identifying the change instruction is given to the change instruction in the change instruction generation unit,
the information processing apparatus comprises an ignition condition information processing unit for creating a list of identifiers of all change instructions managed in the change instruction management unit when a change instruction is generated in the change instruction generation unit and adopting the list as ignition condition information, and
the ignition condition information is further recorded in the change instruction in the change instruction generation unit.

5. The information processing apparatus according to claim 1, wherein
the information processing apparatus comprises an ignition condition information processing unit for listing the change instructions managed in the change instruction management unit when a change instruction is generated in the change instruction generation unit and adopting the list as ignition condition information, and
the ignition condition information is further recorded in the change instruction in the change instruction generation unit.

6. The information processing apparatus according to claim 3, wherein
the information processing apparatus comprises an ignition condition information processing unit for making a comparison between the ignition condition information recorded in the change instruction received from the change instruction synchronizing unit and the number of the change instructions recorded in the change instruction record unit for each apparatus issuing the change instruction and performing processing starting at the change instruction with the minimum total of the number of change instructions recorded in the ignition condition information among the change instructions satisfying a condition that the number of the change instructions recorded in the ignition condition information is smaller than or equal to the number of the change instructions recorded in the change instruction record unit.

7. The information processing apparatus according to claim 3, wherein
the information processing apparatus comprises a conflict finding unit for making a comparison between information pieces as the change targets of the change instruction received from the change instruction synchronizing section and the change instruction recorded in the change instruction record unit and detecting conflicting change instructions if the change instructions are change instruction for the same information.

8. The information processing apparatus according to claim 7, wherein
when the conflict finding unit detects conflicting change instructions, it checks to see if a change instruction for solving the conflict exists in the change instructions received from the change instruction synchronizing unit, and
if a change instruction for solving the conflict exists, the conflict finding unit performs processing of determining that the change instructions detected as the conflicting change instructions are change instructions not conflicting with each other.

9. The information processing apparatus according to claim 7, wherein
the information processing apparatus comprises a conflict solution unit for transmitting the change description of information recorded in any one of the change instructions determined to contend with each other to the change instruction generation unit and requesting the change instruction generation unit to generate a change instruction.
